(19) United States
(12) Patent Application Publication
(10) Pub. No.: US 2005/0221260 A1
(43) Pub. Date: Oct. 6, 2005

(54) Finger reading label producing system, method and program

(76) Inventors: Junichi Kikuchi, Tokyo (JP); Kenichi Tanabe, Tokyo (JP); Nobuyuki Horii, Tokyo (JP); Takashi Tateishi, Tokyo (JP); Toshinori Nojima, Tokyo (JP); Aiko Tanaka, Tokyo (JP)

Correspondence Address: LORUSSO, LOUD & KELLY, 3137 Mount Vernon Avenue, Alexandria, VA, 22305, US

(21) Appl. No.: 11/090,306

(22) Filed: Mar. 28, 2005

(30) Foreign Application Priority Data
Apr. 2, 2004 (JP) 109736

(51) Int. Cl. G09B 21/00

(52) U.S. Cl. 434/112

(57) ABSTRACT

For enabling many peoples to make an input operation, for producing and recognizing the braille characters and/or normal characters, easily, thereby contributing of spreading the braille labels, widely, on which the braille characters are described, not only forming convex portions on a braille label, corresponding to the contents of braille characters, which are taken into, but also printing out the print character lines thereon, which are taken into. Herein, a user can made selection of a layout for the braille character line and the print character lines, arbitrarily. If there is coincidence between the contents of braille characters and the print character lines, a person other than the visually handicapped person can also recognize the contents of braille characters. Further, an input operation can easily be made by converting the print character lines that are inputted into the contents of braille characters, corresponding thereto, automatically, to be inputted in the condition thereof.

### CROSS-REFERENCE TO RELATED APPLICATION

This application claims, under 35 USC 119, priority of Japanese Application No. 2004-109736 filed Apr. 2, 2004.

### BACKGROUND OF THE INVENTION

1. Technical Field relating to the Invention

The present invention relates to a finger reading label producing system, a finger reading label producing method, and a finger reading label producing program, being applicable into, such as, a tape printing system, for example, being an apparatus for exclusive use thereof, as well as, a tape printing system combining a printer therewith, as a peripheral device for use of tape printing, with a personal computer.

2. Description of Related Arts

Letters or characters to be read by touching (i.e., finger reading characters), such as, the braille and/or emboss characters, are important means for a visually handicapped person to obtain information, other than means of hearing voices, etc., and in particular, today the braille can be found on very many devices and in many places, such as, an automatic ticket vending machine and a road guide, and so on.

The braille is made from a unit combining six (6) points or dots of valid conditions (ON); i.e., three vertical (3) dots and two (2) horizontal dots (being called by a “cell”), and as an apparatus for producing such a line of braille characters, there are already known a braillewriter, a braille typewriter, a braille printer, etc.

The braillewriter includes a plate, upon which a paper is put on, a ruler having a plural number of squares aligned, on which the six (6) points of holes are opened, and a dot pen having a tip portion which can pass through the hole on the ruler.

The braille typewriter produces a combination of the ONs of six (6) dots relating to a character on a printing medium, when key operations are made upon the characters corresponding to those braille.

The braille printer prints out a line of braille data receiving from a personal computer or the like, on a printing medium. Herein, as such the braille printers, there is one of printing out on a paper of size B5 or A4, etc., or others of printing out on a tape, which has a predetermined width and length. There was already proposed a printer, which can print out the braille characters and also normal characters, together (Japanese Patent Laid-Open No. 2001-88358).

By taking conveniences for the visually handicapped persons into the consideration, there will be much desire more than today, of providing information through the brailles. For example, it is convenient, if a line of brailles is added onto a menu in a restaurant. And also, for example, it is convenient if a line of brailles is attached on each of tags of many products.

However, in the conventional arts, an input operation must be done by a person who is familiar with an inscription method of the brailles, with using a device for the exclusive use of that braille; therefore, a rate of penetrating of the brailles does not reach up to a desired level.

If a person tries to make an input operation of a line of normal letters, who is not familiar with the inscription method of brailles, in particular, who is not the visually handicapped person (hereinafter, being called by a “normal person”), so as to make braille software to convert it into a line of braille characters to be printed out; however, the person who tries to make the input operation (the normal person) cannot confirm whether the line of the braille characters converted is truly the line of letters at desire or not; thereby, causing a trouble or difficulty. For example, if producing braille labels to be attached onto tags of plural kinds of products, however there may be cases, where the producer her/himself cannot decide the kind thereof from a result of printing, and where a braille label of correct inscription must be produced newly, again, if it is pointed out that there is an error in the braille inscription on the produced braille label by a person who is familiar with the inscription of the braille characters, but after production thereof, and therefore, the braille labels produced comes to be useless.

For such the inconveniences as were mentioned above, a printer described in the Japanese Patent Laid-Open No. 2001-88358 is preferable, since it is able to stamp or type the braille characters, and the normal letters as well, together.

However, the printer described in the Japanese Patent Laid-Open No. 2001-88358 includes a stamping or typing head for the braille characters and a printing head for the normal characters, being aligned in parallel, in the direction of width of a label. Thus, positional relationships are determined between the braille characters and the normal characters, which are disposed on the label, and therefore, it is poor in the degree of freedom, in particular, in the positional relationships between the braille characters and the normal characters.

### BRIEF SUMMARY OF THE INVENTION

For that reason, there are demands for a finger reading label producing system, a finger reading label producing method, and a finger reading label producing program, with which operations of an input, a print out, and recognition thereof can be made by a large number of peoples, easily, about the finger reading characters and also the normal characters; thereby, contributing to wide spreading-out of the finger reading labels, easily.

For solving such the problem, there is provided a finger reading label producing system, comprising: (1) a finger reading contents take-in means for taking into finger reading contents; (2) a print character line take-in means for taking into a character line to be printed; (3) a printing means for printing the character line, into which the character line take-in means takes, on an unprocessed and convexed finger reading label; (4) a convex portion producing means for producing convex portions corresponding to a reading content, into which the finger reading contents take-in means takes, on the unprocessed and convexed finger reading label; (5) a label layout take-in means for taking into layout information relating to the finger reading contents of the finger reading label to be produced or the character line to be printed; and (6) a controller means for controlling the finger reading contents take-in means, the print character line take-in means, the printing means, and/or the convex portion producing means, in accordance with the layout information taken into.

Further, according to the present invention, for accomplishing the object mentioned above, there is also provided a finger reading label producing method, comprising: (1) a finger reading contents take-in step of taking into finger reading contents; (2) a print character line take-in step of taking into a character line to be printed; (3) a printing step of printing the character line, which are taken into in the character line take-in step, on an unprocessed or convexed finger reading label; (4) a convex portion producing step of producing convex portions corresponding to the finger reading contents, which are taken into in the finger reading contents take-in step on the unprocessed or convexed finger reading label; (5) a label layout take-in step of taking into layout information relating to the finger reading contents of the finger reading label to be produced or the character line to be printed; and (6) a controlling step of controlling sequences of processes among plural numbers of the steps and transmission of information among those plural numbers of the steps in accordance with the layout information taken into.

Moreover, according to the present invention, there is further provided a finger reading label producing program, describing each of the steps of the finger reading label producing method described in the above, with codes which can be executed by a computer.

### BRIEF DESCRIPTION OF THE DRAWING

Those and other objects, features and advantages of the present invention will become more readily apparent from the following detailed description when taken in conjunction with the accompanying drawings wherein:

FIG. 1 is a block diagram showing the electrical construction of a tape printing system according to an embodiment of the present invention;

FIG. 2 is a perspective view showing an outlook image briefly of the tape printing system according to the embodiment;

FIG. 3 is a flowchart showing an outlook of an operation of producing a braille label in tape printing system according to the embodiment;

FIG. 4 is a flowchart showing the details of a confirming process of loading of a label, on which braille dots are stamped or typed in tape printing system according to the embodiment;

FIGS. 5A and 5B are explanatory views of a layout (1) of a brail label according to the embodiment;

FIGS. 6(A1) to 6(B2) are explanatory views of a layout (2) of a brail label according to the embodiment;

FIGS. 7A and 7B are explanatory views showing an example of the braille label produced, according to the embodiment;

FIG. 8 is a flowchart showing the details of a take-in process of the contents of braille characters, according to the embodiment;

FIGS. 9A and 9B are explanatory views showing an input screen of take-in of the contents of braille characters, according to the embodiment;

FIG. 10 is a flowchart showing a preview display process according to the embodiment;

FIGS. 11(A1) to 11(B4) are explanatory views showing a positional relationship between a braille character line and a print character line, in a common writing pattern according to the embodiment;

FIG. 12 is a flowchart showing a printing process and a typing (or stamping) process according to the embodiment;

FIGS. 13A and 13B are explanatory views of a mark printed in a printing process for producing a label, including only the braille characters, according to the embodiment;

FIG. 14 is an explanatory view of a guide groove 51 for a braille printing tape, on which the braille characters are typed or stamped after the printing process thereon, according to the embodiment;

FIGS. 15A and 15B are explanatory views of a typing or stamping operation when the braille characters are made up of two lines according to the embodiment;

FIG. 16 is a flowchart showing an overview of the printing process and the typing process within a process of producing the braille labels, continuously, according to the embodiment;

FIGS. 17A and 17B are explanatory views of dot diagrams according to other embodiment;

FIG. 18 is an explanatory view of a layout of the braille label in printing of vertical writing, according to other embodiment;

FIG. 19 is an explanatory view showing an input screen of a print character line and a braille character line according to other embodiment; and

FIG. 20 is an explanatory view of a guiding structure for the braille typing tape into a typing head according to other embodiment.

### DESCRIPTION OF THE PREFERRED EMBODIMENTS

### (A) One Embodiment

Hereinafter, an explanation will be given about an embodiment, in which a finger reading label producing system, a finger reading label producing method and a finger reading label producing program are applied into a tape printing system, a tape printing method and a tape printing program, according to the present invention. The finger reading character is the braille, which should be targeted to be processed by the tape printing system of the embodiment.

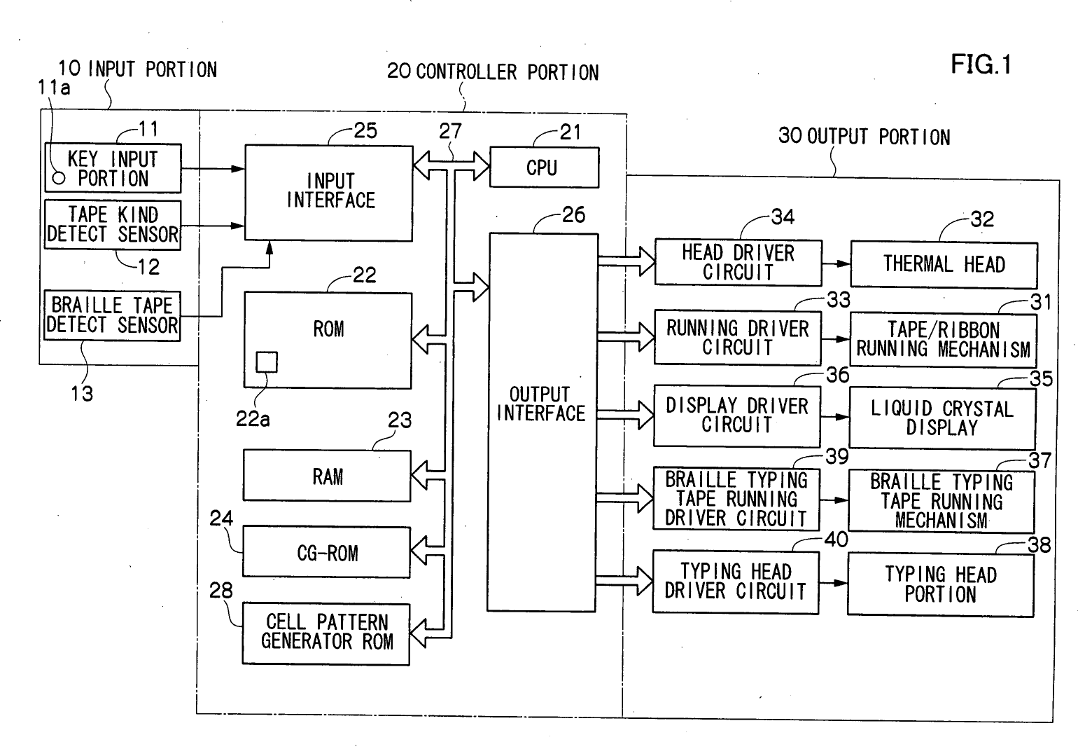

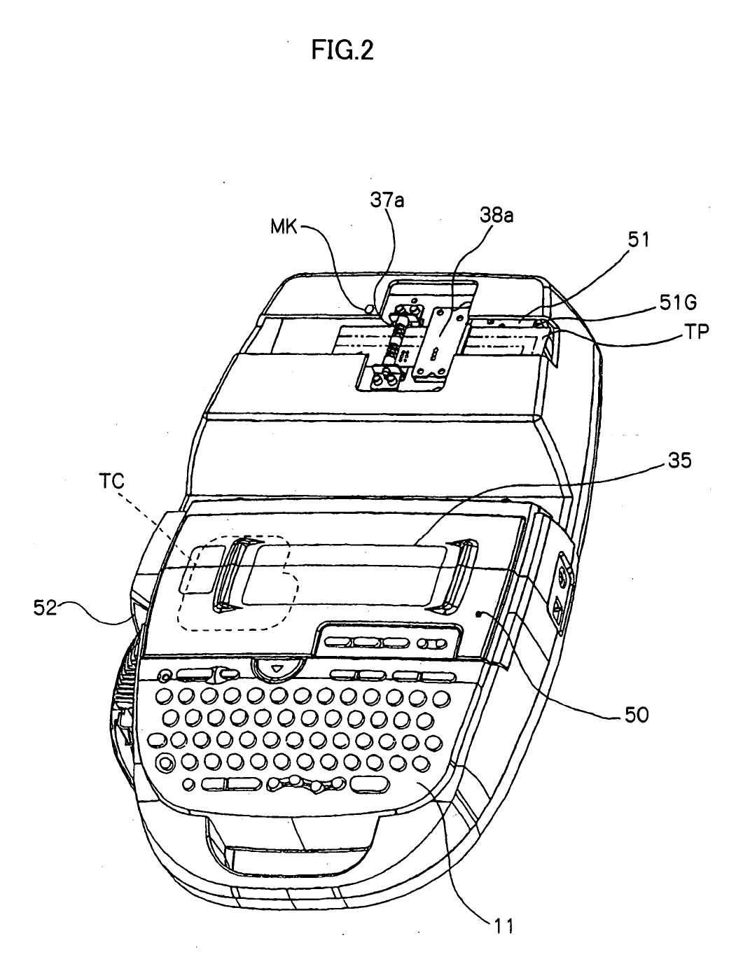

FIG. 1 is a block diagram showing the electrical entire structure of the tape printing system, according to this embodiment, and FIG. 2 is a perspective view showing an outlook image of that tape printing system, briefly. However, the tape printing system (a tape printing apparatus) according to this embodiment is constructed to be an independent device for exclusive use of tape printing.

In FIG. 1, the tape printing system according to the embodiment is built up with, roughly, an input portion 10, a controller portion 20 and an output portion 30. The controller portion 20 executes processes, corresponding to information from the input portion 10 and/or a processing stage at that time to cause the output portion 30 to print or display the process result.

The input portion 10 has a key input portion 11, including a push-down key (or a dial key, a touch panel, etc.), a tape kind detection sensor 12, and also a braille tape detection sensor 13, but the detailed structure thereof is omitted herein.

The key input portion 11 generates character codes and/or various kinds of control data to be given to the controller portion 20. In the case of this embodiment, within the key input portion 11 is provided a braille mode key 1a for shifting into a braille input/print mode (i.e., the braille mode) (this may be an exclusive use key, or may be a common key to be used with other keys in combination, and further may be a group keys of plural kinds, which should be operated in a predetermined order or sequence).

The tape kind detection sensor 12 detects a kind of the tape loaded therein, and provides the tape kind information to the controller portion 20. The kinds of tapes herein determined by information thereof include, such as, a tape for typing or stampling the braille characters thereon (hereinafter, being called by a “braille typing tape”) or others than that, for example, a normal tape, and also a width of the tape, etc. The braille typing tape is a tape, on which a convex portion remains after being typed or stamped by a dot pin, as will be mentioned later, and further can be executed the printing of characters and marks thereon, in the similar manner to the normal tape (however, if the existing tape (i.e., the normal tape) is a tape, on which the convex portion remains after being typed by the dot pin, this can be also applied to be the braille typing tape, and in this case, the existing tape remaining the convex portion after typing may be included within the breadth of protection by the pending patent claims). In this embodiment, it is assumed that the braille typing tape has two (2) kinds (for example, having width of 12 mm and width of 24 mm), in a doubled relationship, for example, differing in the tape width. The tape (including also the braille typing tape) is received within a cassette together with an ink ribbon, and on the cassette is provided a physical identification or discrimination element for defining the kind of tape. The tape kind detection sensor 12 reads out that physical identification element.

A cover 50 having a transparent window in FIG. 2 is provided above a space within an inside of the housing of an apparatus for receiving a tape cassette TC therein, and blow the cover 50 is loaded the tape cassette TC, wherein the tape kind detection sensor 12 reads out the physical identification element of the tape cassette TC under the loading condition thereof.

The braille tape detection sensor 13 detects whether the braille typing tape is inserted or not at a predetermined position after being cut, through execution of the normal tape printing process (including only a tape sending process).

In the apparatus housing of the tape printing system according to this embodiment, a foreground side has a general tape printing structure while a background side a braille typing structure. In a portion of the braille typing structure on the background side, there is provided a running path 51 for running the braille typing tape TP after being cut, while being guided along thereon. On the way of the running path 51, a typing head portion 38 is provided (only a pushing plate 38a of the typing head portion 38 can be seen in FIG. 2, and below this pushing plate 38a, there is provided the main structure of that typing head portion 38), and a running roller 37a, as the constituent element of a braille typing tape running mechanism 37. An end of the braille typing tape after being cut can be inserted into the running roller 37a, and the braille tape detection sensor 13 detects insertion thereof into the running roller 37a.

The output portion 30 includes a printer configuration, a display configuration, and a typing configuration. Herein, the printer configuration is that for conducting a normal printing onto a tape (including both of the braille typing tape and the normal tape), and the typing configuration is that for conducting printing (typing) to make up the convex portion of braille on the braille typing tape.

A tape/ribbon running mechanism 31, mainly being built up with, for example, a stepping motor and a DC motor, etc., is provided for sending out a tape and/or an ink ribbon, which is/are loaded therein, but not shown in the figure, into a predetermined printing position and/or an outside of the apparatus. A printer head (in this case, being a thermal head, for example) 32 is fixed thereto, and the printer head conducts printing onto the running tape through the thermal transfer.

Those tape/ribbon running mechanism 31 and the thermal head 32 are driven by means of a running driver circuit 33 and/or a head driver circuit 34 under the control of the controller 20, respectively. Cutting of the tape after printing is done by means of a cutter not shown in the figure, which is driven by an external force given from a user or a motor, for example. Further, a discharge opening 52 shown in FIG. 2 is provided for the purpose of discharging the tape after printing, and in the vicinity of the discharge opening is provided a cutter for cutting off, though not, shown in the figure.

As a display portion of this tape printing system, a liquid crystal display 35 is provided, having a size of being able to display several characters (for example, 12 letters) of a predetermines size, covering over few lines (for example, 4 lines) thereof. This liquid crystal display 35 is driven by means of a display driver circuit 36 under the control of the controller 20. However, in the case of this embodiment, the liquid crystal display 35 is provided on the cover 50 (see FIG. 2).

A display surface of the liquid crystal display 35 has a character displaying area for displaying strings or lines of inputted characters or the like, a line number indicator for displaying an input condition or the like, about each line of the character lines, which are inputted, and also attribute indicators for displaying various kinds of the attributes or the line, in relation to the character lines inputted. Each of the attribute indicators indicates, by “ON” display thereof, that the attribute is adopted, which is presented by the letters described in the periphery of the display surface corresponding to that attribute indicator. An attribute that is indicted by each of the attribute indicators, may be one about the character size, or one about an input method, such as, an input by the Japanese syllabary or by Roman characters, etc., or one about a unit of a certain degree of cells, such as, vertical writing, central justification, etc., or one about character lines, such as, ornamental letters, an English type face, etc., or one of displaying selection/non-selection about a basic form, for example.

Additionally, for example, the braille typing tape running mechanism 37, which is mainly built up with the stepping motor and/or the DC motor, etc., brings the braille typing tape inserted, as was mentioned above, to run, or stop of running, or be discharged out. The typing head portion 38 provided on the way of the running path thereof is fixed, for example, and the typing head portion 38 conducts the typing upon the braille typing tape running thereon (i.e., forming the convex portion on the braille typing tape). Those braille typing tape running mechanism 37 and the typing head portion 38 are driven by means of a braille typing tape running driver circuit 39 and a typing head driver circuit 40, respectively, under the control of the controller 20.

The typing head portion 38 may be provided only with the dot pins for a one-half (½) cell (i.e., three (3) pins), for example, (or may be provided with the six (6) pins for one (1) cell, or may be provided with a number of pins other than those), and the dot pins, which are indicated to be “ON” by the controller 20, are driven to project in a direction from the back surface to the front surface of the braille typing tape, thereby forming the convex portion (i.e., typing) on the braille typing tape under the stopping condition on running. Further, on the opposite side of the dot pins, there is provided the pushing plate 38a (see FIG. 2), putting the braille typing tape between them, which includes a recessed or concave portion for receiving projection of the dot pins by a predetermined amount thereof.

Further, since the typing head portion 38 can be assumed to be a member, on which wear occurs at the hardest, within such the tape printing system, then there is a necessity of being exchangeable, easily for a user, as a whole or a part thereof. It is preferable to combine the dot pins and solenoids for driving thereof into a unit to be attached with, so that the user can exchange the unit one by one.

The same motor may be used in common, as being the constituent element of the tape/ribbon running mechanism 31, and the motor, as being the constituent element of the braille typing tape running mechanism 37, and also a power transmission device or mechanism, such as, gears and a belt and a pulley, may be provided separately, to be driven independently, upon a target to be running.

The controller 20 is constructed with a microcomputer, for example, being connected with a CPU 21, a ROM 22, a RAM 23, a character generator ROM (CG-ROM) 24, an input interface 25, an output interface 26 and a cell patter generator ROM 28 through a system bus 27.

The ROM 22 is made by one (1) or a plural number of ROM chips, and into the ROM 22 are stored static or fixed data, such as, various kinds of processing programs, dictionary data for conversion between the Japanese syllabaries and the Chinese characters, etc. There are also stored an execution program and/or data 22a of a braille mode, for example. The execution program and/or data 22a of the braille mode include conversion data, a conversion table, and/or a conversion program, etc., for achieving conversion between a character code and a braille code.

The RAM 23 is made of one (1) or a plural number of RAM chips, to be used mainly to be, such as, a working memory, and also there may be stored the fixed data and so on, in relation to an input made by a user. Although being described by “RAM 23” in FIG. 1, the RAM 23 is a broad concept, including other memories, such as, an EEPROM, etc., to be used as the working memory. The RAM 23 has a printer buffer, for storing character lines or strings to be printed out, extending those into the dots in the form thereof; a display buffer, for storing display picture of the character lines or the like; a text buffer, for storing therein character data, etc., in relation to the printing and the input thereof; a character string buffer, for storing character line data, which are obtained by converting the character lines inputted (a sentence of combining the Japanese syllabaries with the Chinese characters therein); a brille character line data buffer, for storing the braille character line data (may be a code line by a unit of one (1) cell, or combination of ON/OFF information corresponding to a cell pattern, or an arrangement ON/OFF information for each of the pins thereof); a line number indicator condition holding buffer for holding a display mode of the line number indicator; and, an attribute indicator condition holding buffer for holding a display mode of the attribute indicator, etc.

The CG-ROM 24 stores dot-patters of the characters and/or marks which are prepared in the tape printing system, and provides a corresponding dot-pattern as an output thereof when a code data of identifying a character or a mark is given. The CG-ROMs may be provided, separately, for use of displaying and for use of printing. The format of storing font information may be either one of an outline font format and a bit-map format.

The cell pattern generator ROM 28 stores the cell-patterns prepared within the tape printing system, and provides an output of a corresponding cell pattern (i.e., the braille character pattern; ON/OFF pattern of six (6) dots for one (1) cell) when a code data of identifying the braille character is given.

The input interface 25 performs as the function of an interface between the input portion 10 and the controller 20, while the output interface 26 performs as an interface between the output portion 30 and the controller 20.

The CPU 21 executes a processing program within the ROM 22, which is determined corresponding to an input signal from the input portion 10 and/or a process stage at that time, with using the RAM 23 as the working area, or utilizing properly the fixed data stored within the ROM 22 and/or the RAM 23, depending upon the necessity thereof; thereby bringing a processing condition and/or a processing result thereof to be indicated on the liquid crystal display 35, or to be printed on a tape, or typed upon a tape.

Next, an explanation will be given about the operation (i.e., a tape printing method) of the tape printing system according to the embodiment. This embodiment is characterized by a producing operation, in particular, of the braille label, and hereinafter the explanation will be made on that producing operation of the braille label.

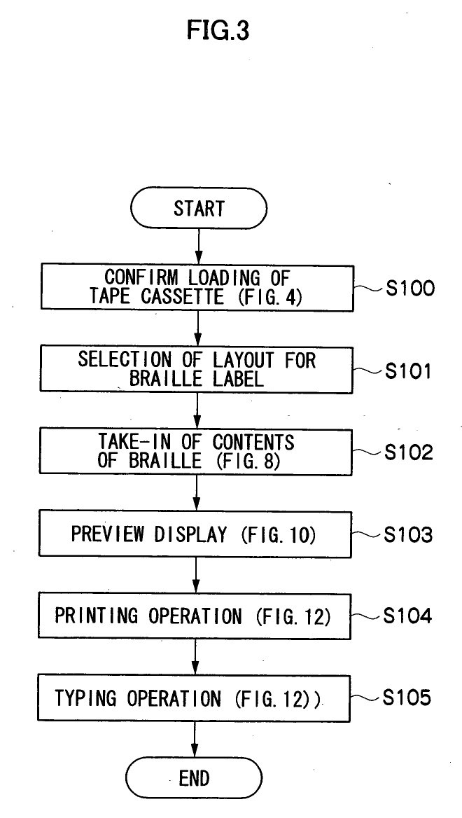

FIG. 3 is a flowchart showing an outlook of the operation for producing the braille label in the tape printing system according to the embodiment.

When an operation is made upon the braille mode key 11a, the CPU 21 starts an execution program 22a of the braille mode, i.e., for producing the braille label, which will be shown by the flowchart shown in FIG. 3.

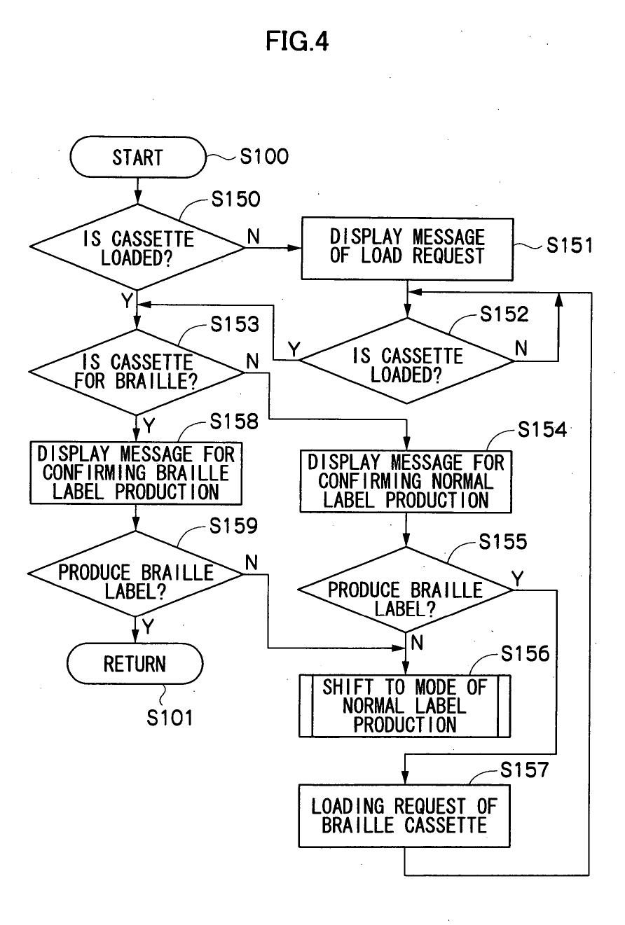

In this instance, the CPU 21 confirms whether the tape cassette is loaded or not, in relation to the braille typing tape, into the tape printing system (S100). FIG. 4 is a flowchart showing the details of this confirmation process of loading this braille typing tape therein.

In the confirmation process of loading the braille typing tape, first the CPU 21 determines whether the tape cassette is loaded or not (S150). If determining that the tape casette is not loaded, it indicates a message of requiring the loading of a cassette of the braille typing tape (S151), and waits for the loading of that tape cassette (S152).

In the cases where the tape cassette is loaded from the beginning or when the tape cassette is loaded responding to the message requiring the loading thereof, then the CPU 21 determines whether that tape cassette loaded is the tape cassette or not, which is in relation to the braille typing tape (S153).

If the tape cassette loaded therein is the normal tape, but other than that braille typing tape, then the CPU 21 displays a message of asking a user whether the CPU 21 should continue the operation for producing the braille label, or should shift to the operation for producing the normal label; and then, the CPU 21 determines the operations made responding to that made by the user (S154, S155).

In a case where the user makes the operation indicative of shifting into the operation for producing the normal label, the CPU 21 shifts the condition of the system into the mode for producing the normal label (S156). On the other hand, if the user makes an operation indicative of continuing the operation for producing the braille label, then the CPU 21 makes a message displayed, requesting to change the tape cassette loaded into the cassette for use of the braille typing (S157), and then the CPU 21 turns back to the step S152 mentioned above.

In the case where the cassette for the braille typing tape is loaded from the beginning, or where the cassette for the braille typing tape comes to be loaded responding to the various kinds of those error messages, then the CPU 21 displays a message of asking the user, whether the braille label is produced or the normal label, and then the CPU 21 makes determination upon basis of the operation made by the user responding thereto (S158, S159). In a case where the user makes an operation to produce the normal label, then the CPU 21 shifts to the step S156 mentioned above, thereby shifting the condition of the system into a mode of producing the normal label.

On the other hand, when the user makes an operation of indicating to produce the braille label, the CPU 21 proceeds into a process of selecting a layout for the braille label (S101 in FIG. 3).

In the case of this embodiment, the braille label may be printed out, not only in the form of the braille character, but also in an ink character (normal character is called by the “ink character”, in comparison to the braille character; hereinafter, being called only by “character” or “print character”).

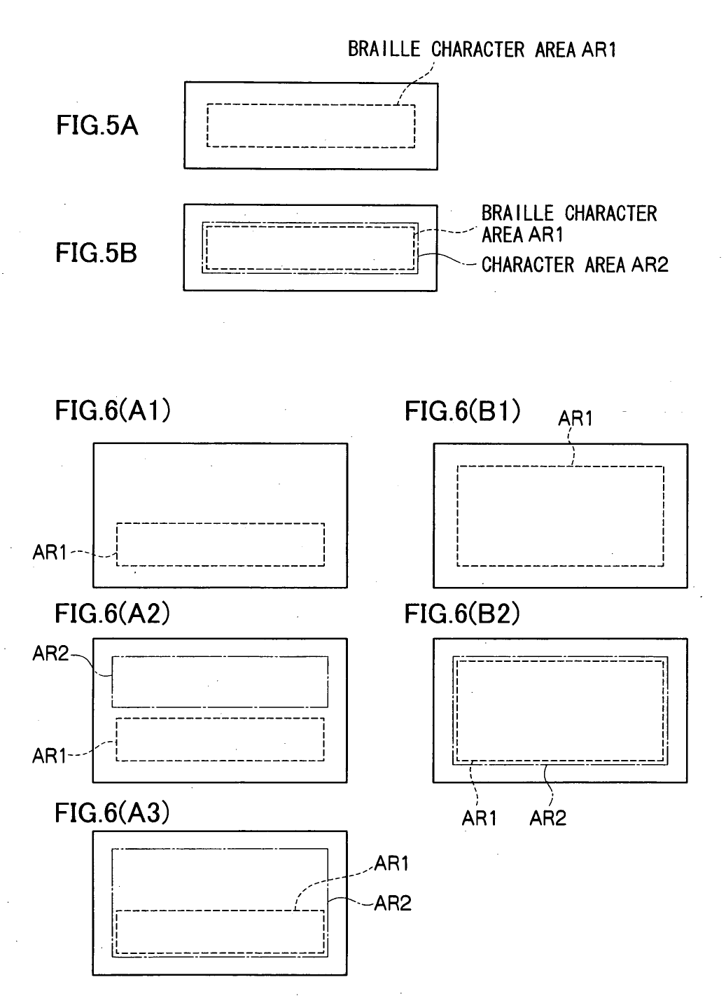

FIGS. 5A through 6(B2) are explanatory views for sorts or kinds of layouts of the braille labels, and in particular, FIGS. 5A and 5B show the case where the braille typing tape, which is loaded therein, has a width of 12 mm, while FIGS. 6(A1) to 6(B2) show the case where the braille typing tape, which is loaded therein, has a width of 24 mm. Further, in those FIGS. 5A through 6(B2), a rectangular of broken lines indicates a braille character area AR1, and another rectangular of one-dotted chain lines indicates a character area (i.e., the ink characters area) AR2.

In the case where the braille typing tape, which is loaded therein, has a width of 12 mm, a line of the braille characters is limited only to one (1) line. FIG. 5A shows a layout of the braille label of having only the braille characters, while FIG. 5B shows a layout of the braille label (i.e., an overwriting layout), having the braille characters and the characters (i.e., the ink characters) overwritten thereon. In case of FIG. 5B, the number of lines of the characters (i.e., the ink characters) is not limited only to one (1) line, in the same manner to the braille characters, and it may be allowed up to the maximum line numbers, within which the printing can be made on the normal tape having the width of 12 mm. In this case, for example, one (1) line of the braille characters corresponds to that of plural numbers of lines, which is extended into the ink characters on one (1) line.

In the case where the braille typing tape, which is loaded therein, has a width of 24 mm, a line of the braille characters may be one (1) line or two (2) lines. In the case of one (1) line, there may be two (2) cases: where the two (2) lines of the braille characters lie only on the lower side thereof, and where the two (2) lines of the braille characters lie only on an upper side. FIGS. 6(A1) to 6(A3) show the layouts of the braille labels when the line of the braille characters lies on one (1) line at the lower side; in particular, FIG. 6(A1) shows the layout of the braille label having only the braille characters thereon; FIG. 6(A2) shows the layout (a common writing layout) including the braille characters and the characters (i.e., the ink characters) aligning in parallel with; and FIG. 6(A3) the layout of an overwriting layout thereof. FIGS. 6(B1) and 6(B2) show the layouts of the braille labels where the braille characters lie on two (2) lines; in particular, FIG. 6(B1) shows the layout of the braille label having only the braille characters thereon; and FIG. 6(B2) shows the overwriting layout thereof. Although illustrations of the layouts are omitted herein, in the case where the braille characters are only on one (1) line at the upper side, they are same to those, being symmetric to upside down shown in FIGS. 6(A1) to 6(A3). Even with the common writing layout and the overwriting layout, the number of lines of the characters (i.e., the ink character) should not be limited only to one (1) line, but is also possible to goes up to the maximum number of lines permissible; for example, one (1) line or two (2) lines of the braille characters correspond(s) to that of the plural numbers of lines extended into the ink characters on one (1) line or two (2) lines.

However, in the explanation, which will be given hereinafter, the system is described to treat only a case where the line number of the braille characters and the line number of print characters are same to each other, when they are in the common writing layout and/or the overwriting layout, and also where the each line of the braille characters and the each line of the printed characters are corresponding to each other in the contents thereof. But, those cases where the braille character line differs from the line of the print character line in the contents in the common writing layout and the overwriting layout will be described later, as the variations of the embodiments according to the present invention.

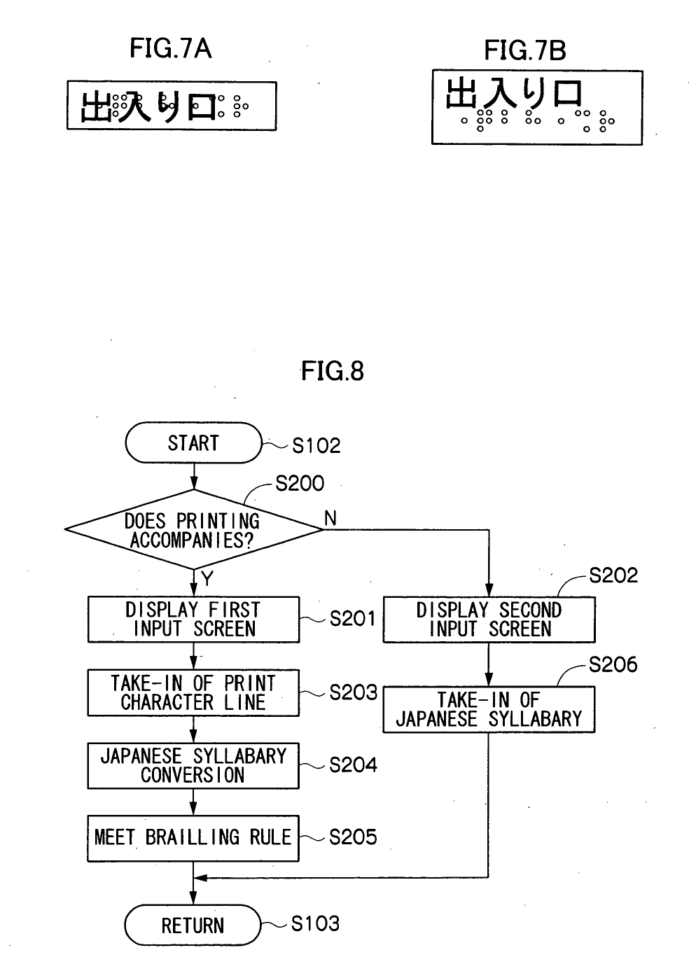

FIG. 7A shows an example of the braille label (displayed “inlet/outlet” in Japanese), which is produced corresponding to the overwriting layout shown in FIG. 5A, and FIG. 7B an example of the braille label, which is produced corresponding to the common writing layout shown in FIG. 6(A2). (Note: FIG. 7A represents the overwriting layout of braille characters and Japanese language (KANA character and Chinese character (Kanji)) meaning “deiriguchi (inlet/outlet)”. Since brallie characters and Japanese language must coincide word-for-word with each other, Japanese language is used as it is, instead of translating it into Roman characters or English, which then do not constitute word-for-word in a positional relationship any more. For example, the Japanese language of FIG. 7A is made of up four characters, while the corresponding Roman character “deiriguchi” is made up of ten characters, and the English translation “inlet/outlet” is made up of twelve characters, resulting in positional deviation from each other. The same applied to FIG. 7B representing the common layout of braille characters and Japanese language.)

In selection of the layout for the braille label, the presence/absence of printing the ink characters, the line number(s) of the braille characters, and the line number(s) of the printed characters may be presented by using the terms thereof, to be selected as an option, or may be made by showing the choices of layout drawings, as shown in FIGS. 5 and 6, to be selected.

When selection is made on the layout of the braille label, then the CPU 21 conducts take-in of the contents of braille characters to be typed (S102 in FIG. 3). FIG. 8 is a flowchart showing the details of the take-in process of the contents of braille characters.

When entering into the process of take-in of the contents of braille characters, the CPU 21 determines whether or not the braille label to be produced accompanies or not the printing of print characters (the common writing layout or the overwriting layout) (S200). Then, if determining that it accompanies the printing, then the CPU 21 displays an input screen of a first kind, through which the character lines can be taken into (S201). If not accompanying the printing of print characters, then the CPU 21 displays a second kind of the input screen, for taking into the contents of the braille characters.

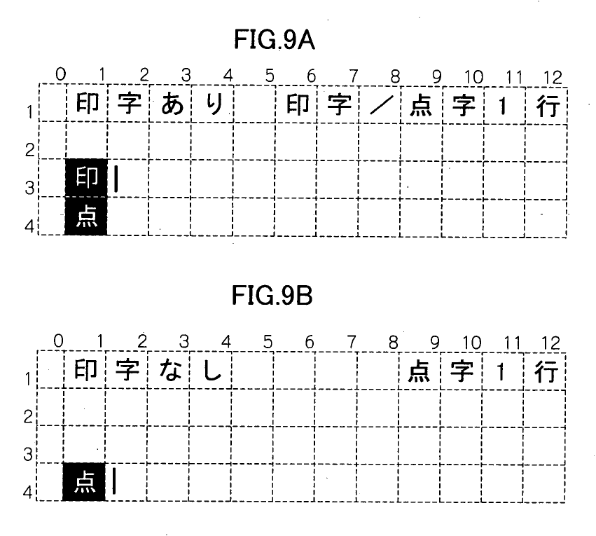

FIGS. 9A and 9B are explanatory views showing the input screen for taking into the contents of the braille characters (an input display screen); and in particular, FIG. 9A shows an input screen for enabling to take into the character strings to be printed, while FIG. 9B shows an input screen for taking into the contents themselves of the braille characters.

On the input screen shown in FIG. 9A, there are indicted the followings: the information indicative of “character(s) to be printed” on the first line, the reversed characters of “print” indicative of being an input line of the printing contents on third line, and the reversed characters “braille” indicative of being a line displayed with the contents of the braille characters on the fourth line. Immediately after the position where the input screen shown in FIG. 9A is displayed, a cursor (a vertical cursor shown in the figure) is located at the left end on the third line. As inscriptions at the right-hand side on the first line, there are displayed “print characters/braille characters”, “print characters/a line of braille characters”, and “print characters/two (2) line of braille characters”, and wherein a first inscription indicates that it is of an layout for only one (1) line, while the second and third inscriptions indicate that they are of the layout of two (2) lines, respectively, and also that they are of the layout that the first and second lines are in the condition of inputting.

On the other hand, on the input screen shown in FIG. 9B, there is displayed the information indicative of “no character to be printed” at the first line, and also the reversed characters of “braille” indicative of being the line for displaying an input of the contents of braille characters at the fourth line. Immediately after displaying the input screen shown in FIG. 9B, the cursor (the vertical cursor shown in the figure) is located at an end of the left-hand side (at a second column) on the fourth line. As the inscriptions on the right-hand side of “no character to be printed”, there are displayed “braille”, “one (1) line of braille” and “two (2) lines of braille”, and the first inscription indicates that it is of the layout for one (1) line, while the second and third inscriptions indicate that they are of the layout of two (2) lines, respectively, and also that the first and second lines are in the condition of inputting.

Further, as the contents of braille characters to be displayed on an input display line at the fourth line on the input screen shown in FIGS. 9A and 9B, it may be possible to display only the characters, which can be converted into the braille characters, or to display them, including a “blank cell” between clauses therein, which can be determined by the brailling grammar, or to display them, including a mark(s) together, indicating that there is located, in the cell, a pre-statement that characters following thereafter are alphabets or the characters following thereafter are the Japanese syllabaries.

Further, into the input display line at the fourth line, it is also possible for the user to select an inscription to be made by means of katakana characters (but, in case of the Latin alphabets and numerals (hereinafter, the alphanumerical characters), as they are), or the Japanese syllabaries (but, in case of the alphanumerical characters, as they are), or the cell patterns. Also, if determining that the contents of braille characters are displayed by means of the inscription of katakana characters or the Japanese syllabaries (including the alphanumerical characters) into the input display line at the fourth line, differing from the inscription of the character lines to be printed out on the third line, they may be displayed by an en-width character (or a single-byte character). Since the contents of braille characters may include a space and the pre-statement mark therein, and are also phonetically inscribed by the Japanese syllabaries, in principal, they can be long, comparing to a line of print characters; therefore, it is very meritorious to apply the display of the en-width character thereon. Hereinafter, an explanation will be made on the assumption that the display of the Japanese syllabaries are made, into the input display line at the fourth line, but not including the pre-statement mark (i.e., the cell) including the “bank cell”.

When displaying the input screen (FIG. 9A), through which the character line to be printed can be taken into, through the process of the step S201 shown in FIG. 8 mentioned above, the CPU 21 takes into the character line to be printed (i.e., a line of the ink characters), which are inputted by the user (S203), and if the inputs are Chinese characters, after conversion into the Japanese syllabaries (S204), it further determines whether they are converted or not in accordance with a rule of the brailling grammar defined unique to the braille. If determining that it is necessary, they are converted and are displayed on the display line for the contents of braille characters at the fourth line (S205). Herein, the user conducts an input operation similar to that of the input of the normal character line, to be executed the Chinese character conversion thereupon, appropriately, onto the third line shown in FIG. 9A, and if in the case of inputting of the Chinese characters, the contents of braille characters are added into the display line for the contents of braille characters, through the conversion process mention above, and further after confirming that the conversion is made in accordance with the brailling rules, or after confirming that the conversion is made in accordance with the brailling rule, in particular, in the case of inputting of the Japanese syllabaries and the alphanumerical characters, the braille characters are added into the display line for the contents of braille characters.

For example, when the Chinese characters “ [symbol] ” are inputted as the character string to be printed, then they are converted into “ [symbol] ” of the Japanese syllabaries in the process of the step S203, and further converted into “ [symbol] - [symbol] - [symbol] (blank)” of the Japanese syllabaries in accordance with the brailling rule within the process of the step S204.

During this input operation, an alarm sound is generated when a return key is operated in case of inputting only one (1) line, while a return mark is displayed when the return key is operated in case of inputting two (2) lines; thereby, displaying the character line inputted thereafter on the right-hand side of the return mark on the same line (i.e., the third line) (may be similar in the manner of the case of only the braille characters). Further, through displaying a mark at the head of a line indicative of the line number on that line, it is also possible to make confirmation, at which number of the lines the input of the character lines is made. Further, through displaying the line head mark at the fourth line, on which the contents of braille characters are displayed, it is also possible to make confirmation, visually, upon which line the braille characters are targeted. Also, in the case where the “blank” is automatically added into the display line of the contents of braille characters, it is possible to add the black at the side of the character line to be printed out, and further it may be left to the setup made by the user, if such the function is applied to or not.

Further, the process of converting into the contents of braille characters may be executed by putting all of them together, after receiving an instruction of completion of inputs of all sentences of the character lines to be printed out. Also, into the display line of the contents of braille characters, it is possible to refuse a deletion of the Japanese syllabaries, but allowing an addition thereof, or if a portion of the character lines to be printed is deleted, then the Japanese syllabaries of the contents of braille character are deleted, always, corresponding thereto, and a relationship may be setup, arbitrarily, between an edition of the character lines to be printed and an edition of the contents of braille characters.

On the other hand, when displaying the input screen (FIG. 9B), through which the contents of braille characters can be taken into, in the process of the step S202 shown in FIG. 8 mentioned above, the CPU 21 takes into the character lines (not include the Chinese characters therein) of the contents of braille characters which are inputted by the user (S206). The input line at this instance lies at the fourth line on the input screen. The CPU also confirms whether they are made in accordance with the brailling rule or not, when taking the character lines into, and if it is doubtful, it is confirmed to the user. For example, when executing an automatic conversion process from the Japanese syllabaries into the Chinese characters on the background, then the CPU confirms whether the presence/absence of the “blank”, if no such “blank” is inputted into the position between clauses where a pause can be determined or inserted into.

Further, it is also possible to accept the change of layout of the braille label, after the process enters into the condition of inputting the contents of braille characters and/or the character lines to be printed, and in such the case, it is also possible to give a consideration to the contents which are inputted in advance. And also, all about dealing with the brailling rule may be left to the user (for example, separated writing thereof is left to the user), or in the place thereof, the user may set up if the system automatically makes the edition process or not, for dealing with the brailling rule.

During when the contents of braille characters shown in FIG. 9A or 9B are displayed on the input screen, although it is possible to instruct to display a preview display (S103 in FIG. 3), or to instruct to print out the characters in general, an instruction is given to the preview display before instructing the printing of characters. In addition, depending upon the sizes of a display surface of the liquid crystal display 35, the preview display may be made in a portion of the input screen for the contents of braille characters.

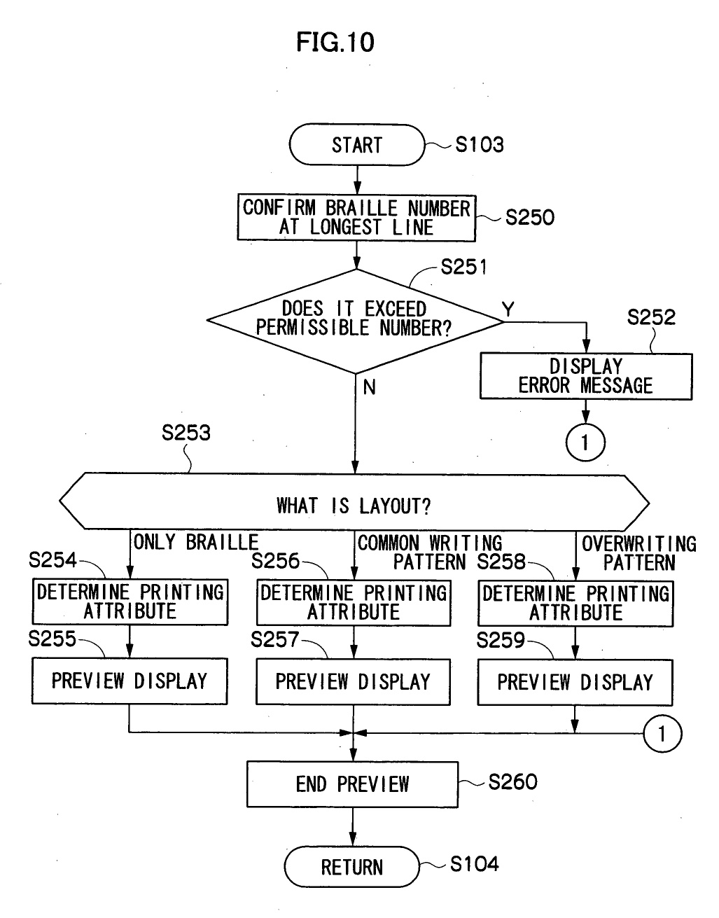

FIG. 10 is a flowchart showing the preview displaying process, which is initiated upon an instruction operation of the preview display.

When stating the process shown in FIG. 10, the CPU 21 recognizes the number of the braille characters (i.e., the number of the cells) at the longest line, which is determined by the contents of braille characters inputted (S250), and determines whether it exceeds or not, the permissible maximum number of braille characters (for example, 45 characters) (S251). And, if the number of braille characters (the number of the cells) exceeds the permissible maximum number of braille characters, the CPU displays an error message of indicative of an effect of that only for a predetermined time period (S252). Differing from the braille characters of a novel, etc., for example, in use of the label, an amount of information to be transmitted is small, and if it is too much, the information transmitted through the finger reading tends to be incorrect; therefore, there is provided an upper limit. The number of braille characters (the number of the cells) may count up also the blank cell(s) and/or the pre-statement cell(s), no may not count up the blank cell(s) and/or the pre-statement cell(s). Further, it is also possible to compare a total number of the characters, putting the braille characters of all of the braille character lines together with the permissible maximum number of braille characters. Also, in the common writing pattern and the overwriting pattern, it is possible to restrict the upper limit, not upon the number of the braille characters, but a number of characters and/or length of the label, etc.

If the number of braille characters (the number of the cells) is equal or less than the permissible maximum number of braille characters, then the CPU 21 determines the layout of the braille label, which was selected (S253).

If the layout selected has only the braille character(s), then the CPU 21 determines the attribute in printing upon the basis of the number of braille characters (or the contents of braille characters) at the largest line (S254), and executes the preview display, with fitting to that printing attribute (S255). For example, as the printing attribute is determined to be a necessary tape length for a length of the braille character area at the largest line of braille characters, by adding the length the braille margins on both sides thereof. However, since an area for one (1) cell is determined by that of the typing head portion 38, therefore, a gap between the cells is made a little bit larger than the distance between the columns within one (1) cell, and furhter the braille character area length is determined by the number of the braille characters. Also, the number of braille characters may be displayed on the input screen by using a portion of the input screen for the contents of braille characters, and in such the case, there is no necessity of confirming the number of braille characters after giving the instructions for the preview display.

Further, as the preview display on such the case, the cell pattern may be also displayed as it is, or it may show only a region of the braille character area, such as, a shading, etc., because of a possibility that each of the cell patterns cannot be seen one by one. It is also possible to leave that selection to the user, if the display is made on the cell pattern column, or if it is made in the braille character area, such as, of the shading. Further, it is also possible to make the display thereof in the braille character area, such as, of the shading, in the preview display utilizing a portion of the input screen, or to make the display by using the cell pattern column in the preview display, utilizing almost of all surface of the liquid crystal display 35, or it is also possible that an area to be served for the preview display is settable or exchangeable by the user.

If the selected layout in relation to the preview display is for the common writing pattern, the CPU 21 determines the printing attribute upon basis of the number of the braille characters (or the contents of braille characters) at the largest braille character line and/or the number of character to be printed out at the largest character line (S256), and it executes the preview display to be fit with that printing attribute (S257). For example, a tape length is determined to fit with the longer one, being selected from the length obtained by adding the braille character area length at the line, which is largest in the number of braille characters, with the braille margins on both sides thereof, and the longest line in the printing. Additionally, for example, the tape length may be determined to fit with the longer one, selected between the braille character area length at the largest line of the braille characters and the longest line in the printing. In the case of the braille label, since the braille margins have no meaning after being attached with, it is possible to pay no consideration onto such the braille margins. Further, for example, the tape length may be determined to fit with the longer one, selected between the length of the braille character area length at the line, being largest in the number of braille characters, and the longest line in the printing, with adding the braille margins thereto.

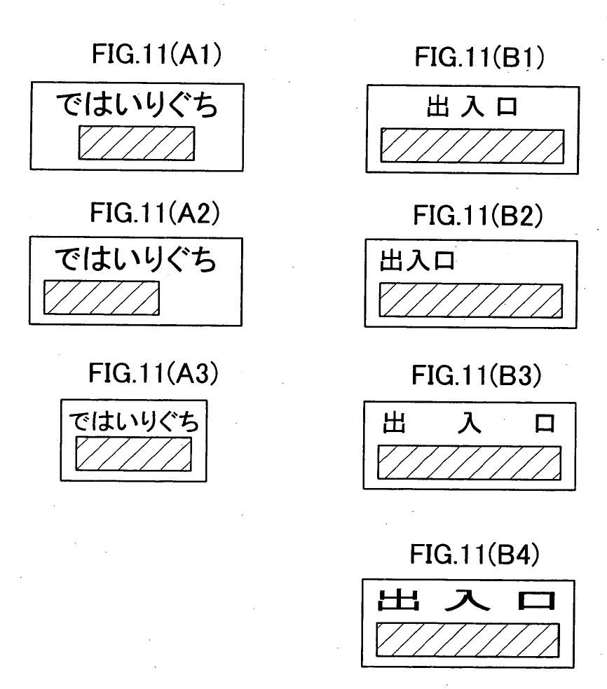

FIGS. 11(A1) to 11(B4) are explanatory views showing a positional relationship, etc., between the braille character line and the print character line in the common writing pattern. However, in those FIGS. 11(A1) to 11(B4), for convenience of explanation, the braille characters are inscribed by means of an area (i.e., being treated by the shading thereon).

FIGS. 11(A1) to 11(A3) show the positional relationship, etc., in a case where the line of print characters will comes to be longer than the line of braille characters, with dealing no process thereupon. FIG. 11(A1) shows the case where the line of braille characters and the line of print characters are fitted or aligned at the center thereof, with no adjustment upon the line of braille characters and the line of print characters. FIG. 11(A2) shows the case where the line of braille characters and the line of printed characters are aligned at the left-hand end, with no adjustment upon the line of braille characters and the line of printed characters. FIG. 11(A3) shows the case where the line of braille characters and the line of print characters are fitted at the center thereof, and further the line of braille characters and the line of print characters are made equal in the length thereof, by bringing/the character size of the line of print character to be smaller than the original one, or by bringing a pitch between the characters to be shorter or smaller than the original one.

FIGS. 11(B1) to 11(B4) show the positional relationship, in a case where the line of braille characters comes to be longer than the line of print characters with no process thereupon. FIG. 11(B1) shows the case where the center fitting is conducted on the line of braille characters and the line of print characters, and the lengths of the braille characters and the line of print characters are not adjusted. FIG. 11(B2) shows the case where the line of braille characters and the line of print characters are fitted or aligned to the left-hand side end, but the lengths of the line of braille characters and the line of print characters are not adjusted. FIG. 11(B3) shows the case where the braille character line and the print character line are fitted at the center thereof, and further the characters of the print character line are distributed or layout equally within the range of the longest length on the braille character line. FIG. 11(B4) shows the case where the braille character line and the print character line are fitted at the center thereof, and they are made equal to each other, by bringing the character size of the print character line to be larger than the original one.

As to the positional relationship between the braille character line and the print character line in the common writing pattern, it may be such that the tape printing system 1 is possible to deal with only one (1) kind, or it may be set or selected by the user at arbitrary timing within the braille mode, and it is also possible to make the positional relationship selectable in the consequences of the selection process of the layout for the braille label. In a case where the tape printing system adopts the selection method, then the preview display will be made depending on the contents of the positional relationship, which is selected when operating an instruction of the preview display.

If obtaining a result that the layout is the overwriting pattern, which is selected in relation to the preview display, in the determination of the step S253 mentioned above, then the CPU 21 determines the printing attribute upon the basis of the number of the braille characters (or the contents of braille characters) at the largest braille character line and/or the number of print characters at the largest print character line (S258), and then the CPU 21 executes the preview display, fitting to that printing attribute (S259). Also in this overwriting pattern, the method for determining the tape length is similar to that in the case of the common writing pattern mentioned above, and also the positional relationship between the braille character line and the print character line in the longitude direction of the tape (see FIG. 11) is similar to that in the case of the common writing pattern mentioned above.

In the case of the overwriting pattern, it may happen that the print character overlaps the effective dot(s) within the cell pattern, and even if trying to display the braille characters within that braille character area, it overlaps the print character. For this reason, the tape printing system adopts any one of the following methods to enable the user to recognize the difference between the print character and the cell pattern (or the braille character area) from the contents of display.

In a first method, print characters and the display of cell patterns (or the braille character area) are displayed alternatively, at a predetermined time period (for example, 0.5 sec). In a second method, while displaying the print characters all the time, the cell patterns (or the braille character area) are blinked at a predetermined cycle. In a third method, the gradation or the color of the print characters and the gradation or the color of the cell patterns (or the braille character area) are changed. In the case of this third method, when the contents of braille characters are displayed by means of the cell patterns, priority is given to the dots of the cell pattern, if the print character overlaps at the position thereof.

When an operation is made upon an end key of the preview display, then the CPU 21 turns the display back to the condition immediately before when the instruction operation is made upon the preview display (S260).

If an instruction is made upon printing during when the contents of braille characters are displayed on the input screen, as shown in FIGS. 9A and 9B, the CPU 21 executes the printing operation on the braille typing tape (S104), and the typing operation on the braille typing tape (S105), thereby completing the braille label.

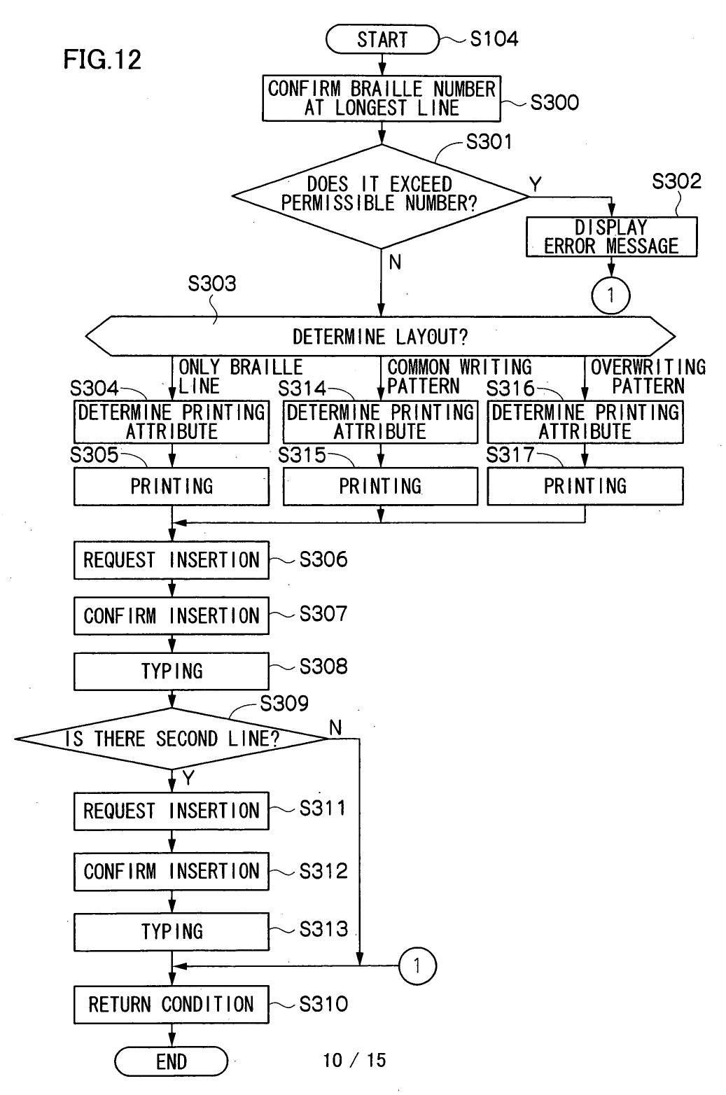

FIG. 12 is a flowchart showing the processes of printing and the typing, which are started by an instruction operation of printing. Further, FIG. 12 corresponds to the case where the normal printing process and typing process are instructed, but an explanation will be made later, about a process of continuous printing/typing, and a process of printing/typing of running numbers, mainly focusing on the differences thereof from the normal printing/typing process.

Also when starting the printing/typing process shown in FIG. 12, the CPU 21 recognizes the number of the braille characters (the number of cells) at the longest braille character line, which is determined by the contents of the braille characters inputted (S300), and the CPU 21 confirms whether the number of the braille characters exceeds or not the permissible maximum number of braille characters (S301) And, if determining that the number of the braille characters (the number of the cells) exceeds the permissible maximum number of braille characters, the CPU 21t displays an error message indicative of that effect, only for a predetermined time period (S302). On the other hand, if the number of the braille characters (the number of the cells) is equal or less than the permissible maximum number of braille characters, then the CPU 21 determines the layout of the braille label selected (S303).

If the layout selected includes only the braille characters, the CPU 21 determines the printing attribute upon the basis of the number of braille characters (or the contents of braille characters) at the largest line (S304), and executes the printing on the braille typing tape, fitting to that of the printing attribute and the selected layout (S305). In the process of this step S305, if the tape printing system has the automatic cutting function, the braille character typing tape is automatically cut off, after the printing process. On the other hand, if the tape printing system does not have such the function, then a display is made for prompting the user to cut off the tape.

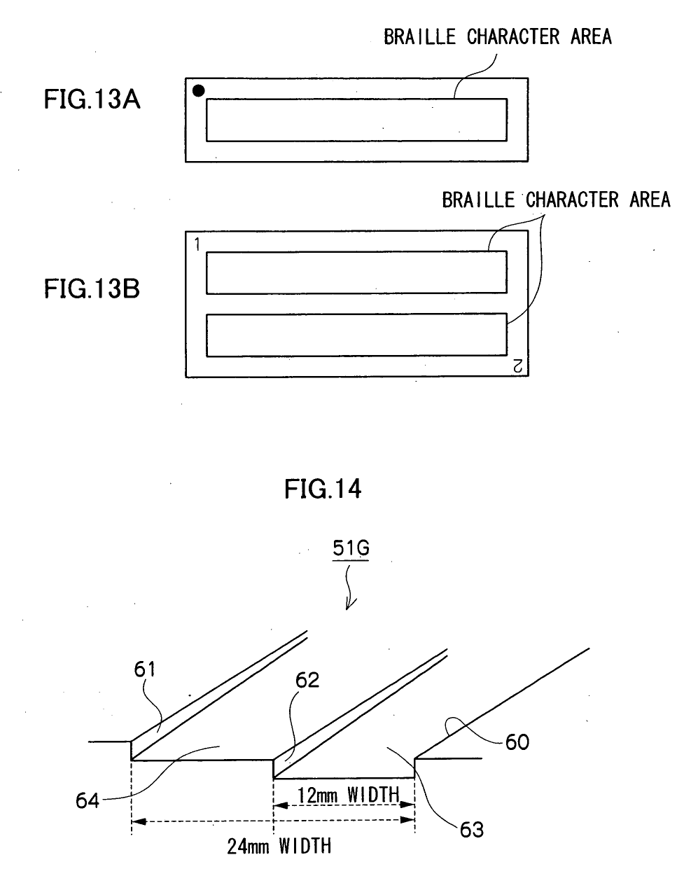

In the printing at this instance, since there is no line of the print characters, no printing is executed for the charactes, however, the mark(s) is/are printed, within an outside of the braille character area, as shown in FIG. 13, being indicative of the direction of the braille label. Further, for example, although the illustration is omitted, as the printing attribute, a length is determined to be a necessary tape length, by adding the braille character area length at the line, which is largest in the number of braille characters, with the braille character margins on both sides thereof, and if the braille margins are shorter than a distance between the thermal head 32 and the cutter, then a cut mark is printed at a top side or an end side thereof (i.e., the braille margin made up through cutting by means of the cutter will is longer than a predetermined braille margin, and then it must be cut off at the position of the cut mark by means of scissors or the like).

The contents of the mark indicative of the direction of the braille label mentioned above are made different from each other, in the shape and at the position of that mark to be printed, depending upon the tape width, i.e., 12 mm or 24 mm, and also the number of the lines of braille characters, one (1) line or two (2) lines, for example. An exemplary shown in FIG. 13A is a mark to be printed in the case where the tape width is 12 mm and the one (1) line of braille characters, and the label is printed together with a mark “•” at the left-upper, so as to make the left-upper end (the left-hand side and the upper side) of the label recognized. An example shown in FIG. 13B is a mark to be printed in the case where the tape width is 24 mm and the two (2) lines of braille characters, and the label is printed together with a mark “1” (or, may be the mark “•”) at the left-upper, so as to make the left-upper end (the left-hand side and the upper side) of the label recognized, and the label is also printed together with a mark “2” reversing upside-down and also left and right, at the right-lower, so as to make the right-lower end (the right-hand side and the lower side) of the label noticeable or recognized. In this case, the marks “1” and “2” correspond to a first time and a second time, of two (2) times of typing, which will be mentioned later, and they indicate an insertion side of the label into the typing head 38 and/or the running roller 37a, for each time of the typing (see FIG. 2). Although the illustration is omitted, in the case where the tape width is 24 mm and the 1 line of braille characters locates at an upper side, the mark “1” (or, may be the mark “•”) is printed only at the left-upper, and in the case where the tape width is 24 mm and the 1 line of braille characters locates at the lower side, then the mark “2” is printed only at the right-lower, being reversed upside-down, and left and right, as well.

It is also possible to apply a method other than those, for the user to visually make the positioning thereof. For example, the tape may have such a shape that the positioning is possible (for example, it may be a label having a sharpened tip, like a pencil (it may be formed in such a shape from the beginning or it may be formed in such a shape through cutting of the tape), or may be printed with a mark for positioning on the reverse side surface thereof, thereby enabling the positioning thereof.

When finishing the printing process, the CPU 21 displays a message of requesting an insertion of an end of the braille typing tape, being cut after the printing process, at which the predetermined mark is attached, into the running roller 37a through the typing head portion 38 (S306), and then the CPU 21 confirms the insertion by a detection output of the braille tape detection sensor 13. And, further if an operation is made on the typing key (S307), then the cell patterns (the braille character patterns) are typed by means of the typing head portion 38 while controlling the running of the braille character typing tape (i.e., the running control by an unit of the cell), and the tape is discharged (S308).

Thereafter, the CPU 21 determines whether the second line is the braille line or not (S309), and when obtaining a negative result thereof, the CPU 21 turns the display back to the condition immediately before the instruction is made upon printing (S310).

In the case where the second line is the braille character line, then the CPU 21 displays a massage of requesting an insertion of an end of the braille typing tape, at which the predetermined mark (differing from that of the first time) is attached, into the running roller 37a through the typing head portion 38 (S311), and then the CPU 21 confirms the insertion through a detection output of the braille tape detection sensor 13. And, further if an operation is made on the typing key (S312), the cell patterns (the braille character patterns) are typed by means of the typing head portion 38 while controlling the running of the braille character typing tape (i.e., the running control by an unit of the cell), and the tape is discharged (S313). And, the CPU 21 shifts into the step S310 mentioned above, thereby turning the display back to the condition immediately before the instruction is made upon printing.

Further, it is also possible to apply a device (such as, a CCD camera, etc.), having a function of read-out of a mark, as the braille tape detection sensor 13, so that the CPU 21 can determine, not only whether the insertion is made or not, but also whether the insertion direction is appropriate or not. In the case where the insertion direction is not appropriate, it is possible to request to insert the tape into the appropriate direction. Also, while having treated a special pattern on the reverse-side surface of the braille typing tape, it is also possible to apply a device (such as, the CCD camera, etc.) having a function of read-out of the reverse-side surface as the braille tape detection sensor 13, so that the CPU 21 can determine, not only whether the insertion is made or not, but also whether the tape inserted is a regular braille typing tape or not. In the case where it is not the regular braille typing tape, an alarm may be generated.

FIG. 14 is an explanatory view of the end portion of a running path 51 for the braille typing tape after the printing process thereof, according to the embodiment (however, this end portion 51G is hidden behind the tape TP in FIG. 2).

On this end portion 51G, in addition to a pair of sidewalls 60 and 61 for regulating the position of the braille typing tape having a tape width of 24 mm, in particular, in the width direction thereof, at the position of a middle, there is also provided a sidewall 62 for regulating the position of the braille typing tape having a tape width of 12 mm, in the width direction thereof. A loading surface 63 between the sidewalls 60 and 62 is inclined, so that it gradually goes up to high, directing from the end side thereof shown in FIG. 14 up to the typing head portion 38 (being flat in the vicinity of the typing head portion 38), and in the similar manner, a loading surface 64 between the sidewalls 61 and 62 is also inclined, so that it gradually goes up to high, direction from the end side thereof shown in FIG. 14 up to the typing head portion 38 (being flat in the vicinity of the typing head portion 38), and an inclination angle of the loading surface 63 is set to be larger than that of the loading surface 64.

Accordingly, the braille typing tape having the tape width of 24 mm is mainly guided on the sidewalls 60 and 61 and the loading surface 64, while the braille typing tape having the tape width of 12 mm mainly guided on the sidewalls 60 and 61 and the loading surface 63. Namely, it is so structured that even the braille typing tape having a narrow width can be guided securely.

Further, it can be also considered to apply a siding guide wall, which moves into the tape width direction (being other embodiment). However, comparing to this, the guiding structure shown in FIG. 14 can securely guide the narrow width braille typing tape due to a simple structure thereof.

As was mentioned in the above, the typing head portion 38 has dot pins for a one-half (½) cell (i.e., three (3) pins), however the dot pins for the one-half (½) cell are provided only below the running path for the braille typing tape having a tape width of 12 mm. Accordingly, with respect to the braille typing tape having a tape width of 24 mm, by one (1) time of typing operation, it is only possible to make typing (producing the braille character) onto the width of 12 mm at the upper side, in the width direction thereof.

For this reason, the typing operation for the layout having two (2) lines of the braille characters, with respect to the braille typing tape having a tape width of 24 mm, or for the layout having only one (1) line of the braille characters on the lower side in the width direction thereof, with respect to the braille typing tape having a tape width of 24 mm, is conducted as below, under the control of the CPU 21.

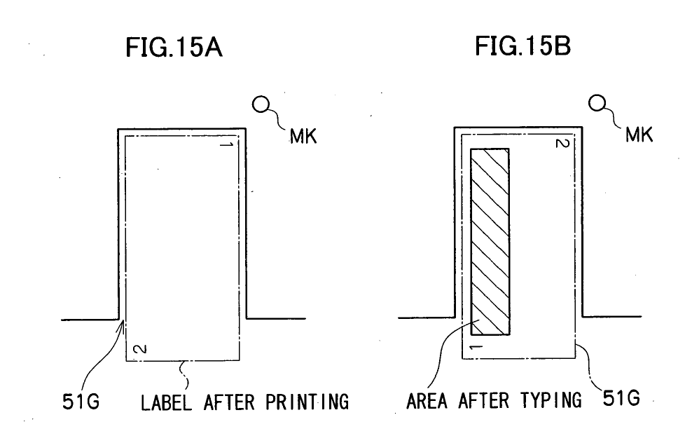

First, an explanation will be given about the former, by referring to FIGS. 15A and 15B. In the case of the tape printing system, only one (1) line of the braille characters can be formed by one (1) time of typing; therefore, in the case of the layout having two (2) lines of the braille characters, it is necessary to conduct the typing operation twice (i.e., the typing operation in the steps S306 to S308 mentioned above, and the typing operation in the steps S311 to S313).

FIG. 15A relates to the typing operation at the first time and shows the direction of insertion of the braille printing tape into the end portion 51G, and FIG. 15B relates to the typing operation at the second time, and shows the direction of insertion of the braille printing tape into the end portion 51G.

In the typing operation at the first time, while fitting the mark “1” (or the mark “•”) at the upper-left on the braille typing tape with a “fitting mark MK” (for example, a mark “∘”; see FIG. 2) on the side to be inserted, which is provided at a predetermined position in an upper portion of the housing, above in the deep side of the running roller 37a on the tape running path 51, the braille typing tape is inserted into, to be typed. Also, in the typing operation at the second time, while fitting the mark “2” at the lower-right on the braille printing tape with the fitting mark MK mentioned above, the braille printing tape is inserted to be typed.

With doing so, in the typing operation at the first time, typing is carried out while moving the braille typing tape from the left to the right when seen from the regular direction thereof. On the contrary to the above, in the typing operation at the second time, typing is carried out while moving the braille typing tape from the right to the left when converting it into the regular direction thereof. For this reason, in the typing operation at the second time, the CPU 21 makes the tape typed thereon, directing from the braille character located at the right-hand side to the braille character located at the left-hand side on that line, and at the same time, not using the cell patter of each of the braille characters as it is, but the CPU 21 makes the tape typed thereon, in accordance with the cell pattern obtained by reversing the original cell patter upside-down, and left and right as well.

Onto the braille typing tape having a tape width of 24 mm, the typing operation is carried out only one (1) time, for the layout having only one (1) line of the braille characters at the lower side in the width direction, but that typing operation is similar to the typing operation at the second time for the layout having two (2) lines of the braille characters onto the braille typing tape having a tape width of 24 mm, which has been mentioned above.

With such the typing control as was mentioned above, it is possible to form the braille label having two (2) or more lines of the braille characters, by means of the typing head portion 38 having dot pins for one-half cell (i.e., having three (3) pins).

Further, it is also possible to provide the dot pins of three (3) pins or six (6) pins for each of lines, respectively, fitting to the maximum number of lines of the braille characters, and in such the case, it comes to be more complex in the structure thereof comparing to the embodiment mentioned above; however, it is possible to make up a simple typing control. Additionally, for example, in the case where the maximum line number of the braille characters is four (4) lines, it is also possible to provide the dot pins of three (3) pins or six (6) pins (for one (1) cell) only for two (2) lines, continuously, thereby enabling to deal with all, one (1) line, two (2) lines, three (3) lines and four (4) lines of the braille characters, through the typing control by two (2) times at the most similar to that of the embodiment mentioned above.

When obtaining a result that the layout of the braille label selected is the common writing pattern, in the determination of the step S303 in FIG. 12, then the CPU 21 determines the printing attribute upon the basis of the number of braille characters (or the contents of braille characters) at the largest braille character line and/or the number of print characters at the largest print character line (S314), and the CPU 21 also executes the printing of the print character lines, fitting to that printing attribute (S315). And then, the CPU 21 shifts into the step S306, to execute the typing operation.

The method for determining the printing attribute is similar to that in the case of the preview display. Also the positional relationship between the print character line and the braille character line in a longitudinal direction of the tape is similar to that in the case of the preview display. Although the direction of the braille label comes to be apparent through the printing of the character line, in the similar manner to the case of the braille label having only the braille characters, a mark may be printed out, so as to indicate the direction of the braille label. Further, the number of typing is only one (1) time when the layout is for the common writing pattern. Depending on which end portion of the cut braille typing tape is inserted, either the braille character line at the upper side or the braille character line at the lower side is obtained (also a reverse control of the cell pattern may be done, appropriately).

When obtaining a result that the layout of the braille label selected is the overwriting pattern in the determination of the step S303 in FIG. 12, then the CPU 21 determines the printing attribute upon the basis of the number of the braille characters (or the contents of braille characters) at the largest braille character line and/or the number of print characters at the largest print character line (S316), and then the CPU 21 executes the printing of the print character lines, fitting to that printing attribute (S317). And, the CPU 21 shifts into the step S306, thereby executing the typing operation.

The methods for determining the printing attribute and the positional relationship between the print character line and the braille character line in the longitudinal direction of the tape are similar to those in the case of the preview display. Further, also in this case, the direction of the braille label comes to be apparent from printing of the character line, but in the similar manner to the case of the braille label having only the braille characters thereon, a mark may be printed so as to show the direction of the braille label. Further, the number of typing in the case where the layout is the overwriting pattern is one (1) time or two (2) times. Depending on which end portion of the cut braille typing tape is inserted, either the braille character line at the upper side or the braille character line at the lower side is obtained (also the reverse control of the cell pattern may be done, appropriately).

Even if the layout of the braille label selected may be the common patter or the overwriting patter, when the typing operation is completed, the CPU 21 turns the display back to the condition immediately before the operation is made to instruct the printing, in the step S310 mentioned above.

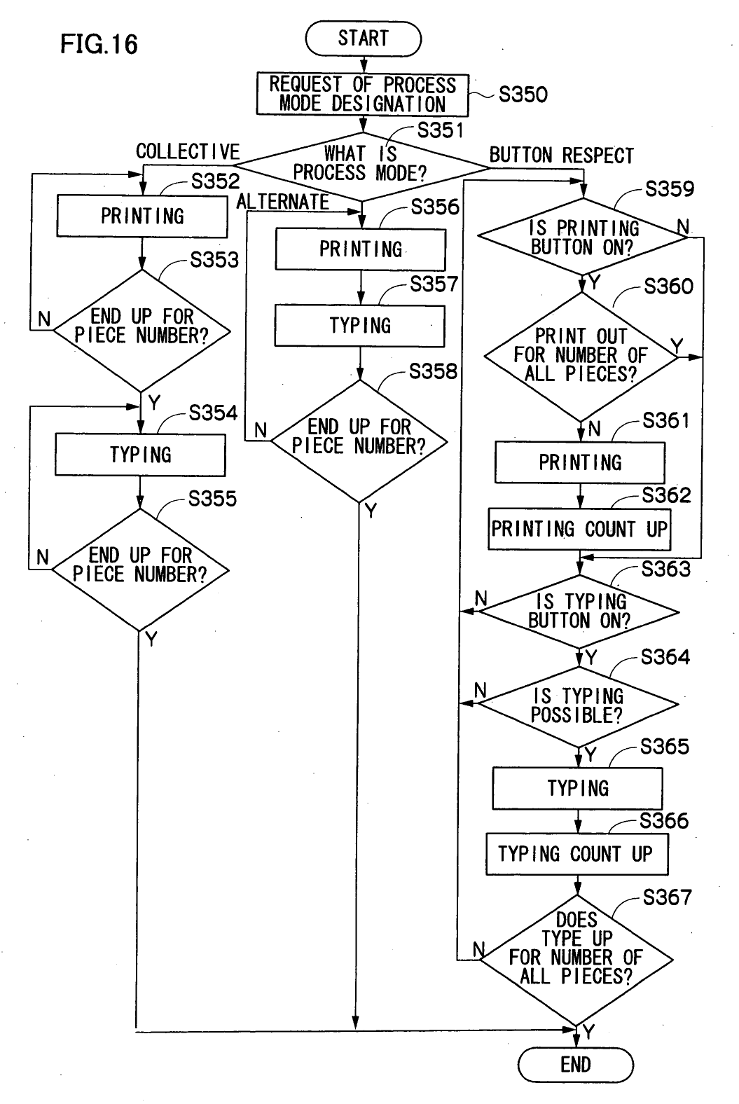

Next, an explanation will be made about the printing/typing process in a continuous producing method (corresponding to the so-called the continuous printing), as being a special producing method of the braille label, by referring to a brief flowchart shown in FIG. 16.

However, designation of the continuous forming method may be made by selection, while displaying a menu asking “normal producing” or “continuous producing” of the braille label (or, further “running producing”, which will be mentioned later), immediately after the print mode key 11a is operated, or displaying a menu asking “normal producing” or “continuous producing” of the braille label (or, further “running producing”, which will be mentioned later), immediately after the start key is operated for the printing process, upon a stage of displaying the input screen for the contents of braille character or the like. Further, immediately after the “continuous producing” is designated, the number of pieces to be produced is also taken into from the user. In the process portion shown in FIG. 16, there is further shown a case that the printing and the typing are carried out with the “continuous producing”, wherein the contents of braille characters or the print character lines are inputted already.

When entering into the process shown in FIG. 16, the CPU 21 displays a message of asking to make selection: a lump or collective mode of conducting the printing, collectively, and then conducting the printing, collectively; or an alternate mode of conducting the printing and the typing, alternately; or a button respect mode of conducting the printing and the typing according to the operation of a printing button and a typing button (S350), and the CPU 21 determines the contents selected by the user responding thereto (S351).

When the corrective mode is selected by the user, the CPU 21 executes the printing processes for the designated number of pieces to be produced (S352, S353), and thereafter, executes the typing processes for the designated number of pieces to be produced (S354, S355). In this case, in the collective mode, the printing process is executed continuously, even if the user leaves her/his seat during the printing process.

Also, when the user selects the alternate mode, immediately after executing the printing process upon a certain one (1) piece (S356), the CPU 21 executes the typing process (S357), immediately; thereby executing such the printing process or the typing process by a unit of one (1) piece, repeatedly, for the designated number of pieces to be produced (S358).

When the button respect mode is selected by the user, the CPU 21 waits for the operation of the printing button and the typing button (S359, S363).

Further, when the user selects the button respect mode, the CPU 21 counts up a printing number parameter, as well as, executing the printing process, after confirming that the printing processes are not yet finished for the designated number of pieces to be produced (S360 to S362). On the other hand, when the typing button is operated, the CPU 21 counts up the typing number parameter, as well as, executing the typing process, after confirming the fact that there is remained a cut braille typing tape, on which the typing can be made, by comparing the number of pieces of the printed out and the number of pieces of the typed (S364 to S366). And, when the printing processes and the typing processes are also executed for the designated number of pieces to be produced, then the CPU 21 ends up a series of processes (S367).

In the cases of the alternate mode and the button respect mode, the producing is operated without designation of the pieces number to be produced, and the user may indicate to end up the continuous production when she/he decides that the necessary production is made, thereby bringing the system to complete the continuous producing process. Also, not at the times of the indication of the continuous producing, but the indication of normal producing, although different from the embodiment mentioned above, the process may be started by the printing button and the typing button. In such the case, it is possible to achieve the producing of plural number of pieces (in other words, the continuous producing), though no indication is made of continuous producing. Even in this case, validity/invalidity of the typing button is determined by the valid number of times of the printing button, while the validity of the printing button is determined irrespective of the typing button. Further in the above example, the user can select the mode of executing that continuous producing when the “continuous producing” is indicated; however, the tape printing system may be so constructed so as to correspond to only any one (1) piece of buttons of those modes.

Next, an explanation will be made, mainly, on the differences, in particular, about the printing/typing process in the running producing method (corresponding to the so-called the running printing), as being the special producing method for the braille label, comparing to the continuous producing mentioned above. Also, designation of the running producing method is executed on a selection screen for use of designation of the continuous producing method, for example.

In the case of this embodiment, it is assumed that the print character line and the braille character line are corresponding to each other; therefore, the running number producing function can be applied onto (1) a case where the contents of braille characters is changed in running number within the layout including only the braille character therein, and (2) a case where the print character line and the braille character line are changed in running number in synchronism therewith. Furthermore, it is also possible to (3) change only the contents of braille characters in running numbers within the layout including only the braille character therein, and in such the case, a method for achieving this is that in accordance with the case (1) mentioned above.

Accordingly, the designation of the running numbers producing method is accepted, in the case where the running numbers portion is defined onto the contents of braille characters within the layout including only the braille characters, or the case where both the braille character line and the print character line are defined with the running numbers portions, within the layout including the braille charcter line and the print charcter line therein, but the designation of the running numbers method is not accepted, in the case where the running numbers portion is defined only onto the braille character line within the layout including the braille character line and the print character line therein, or in the case where the running numbers portion is defined only onto the braille character line within the layout including the braille character line and the print character line therein.

Although, as a variation of the embodiment mentioned above, there can be listed up a case where the print character lines and the contents of braille characters may have no relationship therebetween, in such the case, it is possible to receive the designation of running numbers producing method when the running numbers portion is defined only onto the braille character line within the layout including the braille character line and the print character line therein, or when the running numbers portion is defined only onto the print character line within the layout including the braille character line and the print character line therein.

Also in case of producing the braille labels in a plural number thereof with the running numbers producing method, it is also possible to make the process mode selectable, from the collective mode, the alternate mode and the button respect mode, by the user. Further, it is also possible to provide a mode, such as, of conducting the printing/typing, for an instruction of producing a label of next number by the user, thereby including this mode to be a one of the selection targets. Further, it is also possible to inhibit that mode with the braille label, on which the running numbers portion of the braille character line and the print character line are synchronized with, and to set the mode into the alternate mode, automatically, thereby ascertaining the synchronization of the running numbers between the braille character line and the print character line.

Further, even in the case of designating the continuous producing method and/or the running numbers producing, it is also possible to accept only the printing process and/or the typing process, being same to those that is/are already executed, through a special key operation. For example, it is possible to allow the producing of the print label in relation to the running numbers having the same running numbers of that immediately before. In the case of producing a plural number of pieces, there is a possibility that mis-producing may occurs for about one (1) piece or two (2) pieces thereof, so as to deal with this. Even in the normal producing operation for producing one (1) piece of the braille label, it is also possible to accept the printing process or the typing process, being same to that already executed, through the special key operation.

As described in the above, although the explanation is made, mainly about the function of producing the braille character (s), the normal label can be also produced, and the producing method thereof is same to that in the existing system.

With the embodiment mentioned above, the following effects can be achieved. Further, the explanation was made on the effects in the above, appropriately.

According to the embodiment mentioned above, it is possible to produce, not only the braille label including only the braille character line, but also the braille label including the braille character line and the print character line. Thus, it is possible to produce a variety of braille labels. A producing apparatus for exclusive of the braille label cannot be highly expected to increase in use, in particular, the penetration rate thereof; however, since the tape printing system according to the embodiment mentioned above is a general-purpose machine, and therefore it may be easily purchased by many peoples, this contributes the wide spread-out of the braille labels. Also, the braille label including the print characters therein can not only prevent an error in sticking, but also explain the contents thereof to the visually handicapped person by other than the visually handicapped person, even if the convex portions of braille characters are collapsed, or provide any information to the visually handicapped person by the person other than the visually handicapped person, even if the contents of the braille character line and the print character line are irrelevant to each other. Listing up one example of the later, if the print character line is written to read “braille information” for example, the person other than the visually handicapped can tell “there is braille” to the visually handicapped person.

Also, with the embodiment motioned above, since the contents of braille characters can be inputted by converting the sentence mixing up the Japanese syllabaries and the Chinese characters, as the original input, which can be made through the same input method when producing a general label, it is possible for a person who is not familiar with the brailling rule, to make the input operation thereof. In this respect, it can be also said that it contributes the spreading of the braille labels.

### (B) Other Embodiments

Although the description is made upon various modified embodiments in the explanation of the embodiment mentioned above, there can be also listed up the following modified embodiments, which will be explained hereinafter.

(B-1) Embodiment of Finger Reading Characters

In the embodiment mentioned above, although it is explained that the finger reading characters are braille characters, for example, based on the Japanese syllabaries for use of Japanese language, the present invention can be also applied to the braille system for use of other languages. Further, the present invention can be also applied to the case where the finger reading characters are the emboss characters.

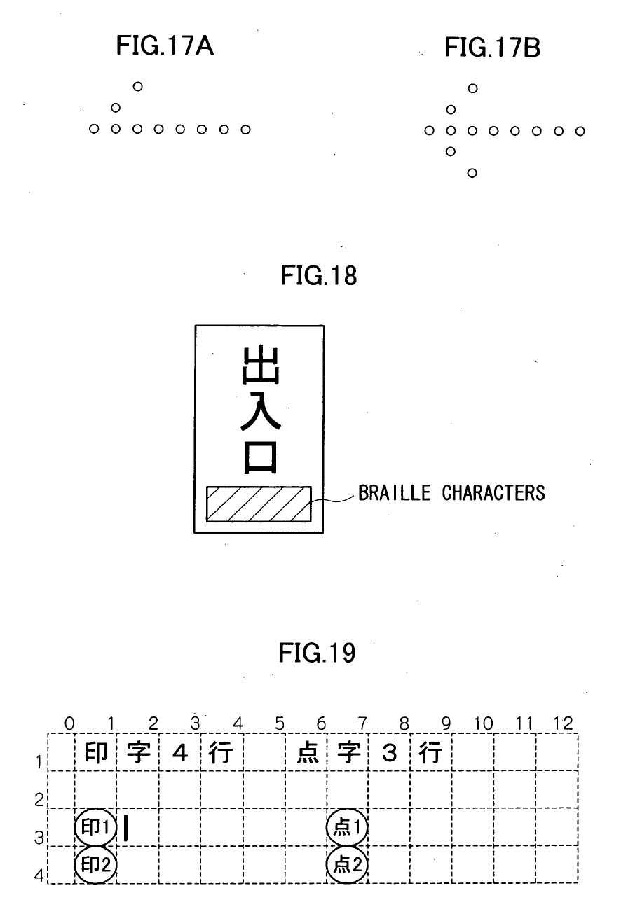

Also, although the convex portions are the braille characters, which are formed in the braille label, in the embodiment mentioned above, the dot diagrams as shown in FIGS. 17A and 17B may be formed. FIG. 17A shows a left-directed arrow which is formed by using the dot pins for one (1) cell (six (6) pints; however, it may be one having three (3) pins), and FIG. 17B shows the left-directed arrow which is formed by using the dot pins of two (2) cells in the width direction thereof (twelve (12) pins; however, it may be one having six (6) pins in the width direction). Those dot diagram(s) to be formed may be selected from the dot drawings, which are prepared within the apparatus in advance. As the method for selection in this case may be applied one that is similar to the selection method of the marks, which was adopted in the existing tape printing system, etc. Namely, the selection may be made by; i.e., first, selecting a desired group (for example, a group of arrows) from the plural choices, each indicating the group names thereof, and then selecting the dot diagram at desired (the left arrow) from the plural choices within that group. Additionally, it is also possible to accept producing and registering of the dot diagram(s), with the method similar to that method for registering a user-defined character. Further, it is also possible to accept the input for producing the dot diagram, but only one (1) time (the producing method is similar to that for producing of the user-defined character).

(B-2) Mode of Input

Further, in the embodiment mentioned above, there is shown that the input information is taken into from the key input portion 11, which is provided in the body of the tape printing system; however, the information may be taken into through a cable from an input portion of separate body or an optional input portion. The input portion of separate body may be made to be connectable to the main body, having a key arrangement in accordance with a braillewriter available on a market, thereby making the inputting easy for the visually handicapped person. In this case, reception of the key operation may be notified by voice. A display may be applied to a display portion, on which the dot makes advance or retreat movement, to be readable through the finger reading, too. In the case of applying the input portion of separate body, having such the key arrangement in accordance with the braillewriter, as a display field for the contents of braille characters, there may be provided one, on which the display is made by the cell patterns, and also another one, on which the display is made by the Japanese syllabary, thereby displaying the information inputted as it is, on the display field of displaying by the cell patterns, while displaying the information inputted, after being converted into the Japanese syllabaries, on the display field of displaying by the Japanese syllabary. Further, it is also possible to read into an image of the existing braille label, so that the reading or the like thereof is inputted and/or displayed.

(B-3) Mode of Layout

Furthermore, in the embodiment mentioned above, there is shown the case where the print character line is written horizontally. However, as shown in FIG. 18, a layout for writing the print character line vertically and the braille characters horizontally may be prepared. Also in this case, the method applied to the conventional tape printing system may be applied to the printing process. On the other hand, onto the braille is typing tape, being cut after printing, the typing process may be done while running the tape in a groove, automatically or manually, for example, in the similar manner to that of a card reader of the method of passing through the groove. However, in this case, the permissible upper limit of the number of braille characters is made stricter than the other cases. Also, there may be provided a permissible upper limit to the number of print characters, so that the braille characters can be prevented from being unaware in the presence thereof if the number of print characters is increased too much.

Also, in the embodiment mentioned above, there is shown the tape printing system, in which the layout for the braille label is selectable; however, it may be a tape printing system, in which the layout for the braille label is fixed to either one of the common writing pattern or the overwriting pattern.

(B-4) Mode of Label Length Setting

In the above, there is shown the embodiment, in which the length of the braille label is determined, depending upon the maximum character number on the print character line, the maximum braille character number on the braille character line; however, in the place of or in addition to such the function, there may be provided a fixed length function, wherein the user designates the length of the braille label with a concrete or detailed numeral value thereof. In the case where the length necessary exceeds the length designated, an alarm may be generated, irrespective of a fact that the cause of excess length lies in the print character line or not, or alternately, in the case where the reason of coming over lies only in the braille character line, it is also possible to accept that necessary length, thereby permitting production of the braille label. Alternately, in the case where the cause of excess length lies only in the print character line, the print characters may be pushed into the length designated to be fixed, through a method of compulsively reducing the character size or putting the characters close in the distance therebetween.

(B-5) Modes of Display Line Number of Label and Display Mode of Input Screen

Further, as described above, there is shown the embodiment, wherein it is possible to deal with both the print character line and the braille character line, in a plural number thereof, however it is also possible to limit the line number to one (1) line of either one of them, or to provide a difference in the maximum line number even in combination with the plural number of lines, or further, it is also possible to provide a restriction of brining any line number to be a number being equal or larger than that, except for the case where the braille label is made of only the braille characters. Also in such the cases, it is possible to bring the contents of the print characters and the braille characters to be related to each other, or not, and this can be selected by the user. Further, it is also possible to describe independent contents on each line of the plural number of character lines and the like. Such the limitation of the line number as was mentioned above may be changed, depending upon the tape width. For example, in the case of the common writing pattern of accepting the input of lines in plural number thereof, for both the print character line and the braille character line, if a new line overlaps the area of the braille character area through an input of a new line (i.e., “Enter”) in the inputting of the print characters, it is also possible to refuse that input of the new line.

FIG. 19 shows a variation of the input screen in the case of accepting the input of the lines in plural number thereof, for both the print character line (displayed “four (4) lines of print characters” in Japanese) and the braille character line (displayed “three (3) lines of braille characters” in Japanese), wherein the input display portions for the print character line and the braille character line are provided on both sides, each for two (2) lines, and a scroll display can be made for those display lines of two (2) lines. Therefore, this embodiment can deal with the display, even in a case of the line number being large. In this case, the display line on the print character line and the display line on the braille character line may be matched with each other.

(B-6) Modes of Character Arrangement of Print Characters and Braille Characters

The above-mentioned embodiment is disclosed to insert the blank (a blank cell) for each sentence, in accordance with the brailling rule, in particular, with respect to the braille character line, however it is also possible to insert the blank for each sentence in the portion of the print character lines. Alternatively, the heads of sentences on the braille character lines and the print character lines may be aligned and displayed. The blank may be inserted into the portion of the print character lines, for each sentence, on the label that is produced. Further, also the character arrangements (i.e., the centering, the left margin, the allocation, etc.) may be made upon the print character line and the braille character line, by a unit of sentence, on the label that is produced. With this, it is possible to recognize the correspondence in the contents between the braille characters and the print characters, by a fine unit thereof.

(B-7) Mode of Mark Indicating Direction of Braille Label

Also, in the embodiment mentioned above, there is disclosed the example, wherein the mark is attached onto the braille label for notifying the direction thereof, however the direction may be notified by means of a mark printed on a stage of working processes or by means of a mark of the braille characters.

(B-8) Mode of Preview Display

Furthermore, in the embodiment mentioned above, it is disclosed that the braille character area can be displayed, also with the shading or the like thereon, in particular, when displaying the preview; further, it is possible to print the shading, together with a frame and a pattern, etc., within the braille character area, in particular, within the layout of only the braille character line and/or the layout of the common writing patter, thereby making the braille character area remarkable, and this function may be brought to be one of setting items by the user.

(B-9) Mode of Shifting to Braille Mode

Moreover, in the embodiment mentioned above, it is disclosed that the operation is shifted into the braille mode, when the user makes the key operation thereof; however, also in the normal operation mode, it may be shifted into the braille mode, automatically, at that time when the tape cassette is exchanged to a new one, receiving the braille character typing tape therein, after conducting that exchange of the tape cassette.

(B-10) Mode of Determining Margin for Braille Label

In the embodiment mentioned above, it is disclosed that the length for the braille label is determined to be that obtained by adding the braille character margins on both sides to the braille character area length at the line, which is largest in the numbers of braille characters thereof, or that obtained by adding the braille character margins on both sides to the length of print characters at the line, which is longest in the print characters thereof; however, in the case if the length of print characters at the longest print character line is longer than that, which is obtained by adding the braille character margins on both sides to the braille character area length at the largest line of the numbers of braille characters, that length of print characters at the longest print character line may be determined to be the length of the braille label, or other rules may be applied thereto.

(B-11) Mode of Width of Braille Label

Also, in the embodiment mentioned above, there are disclosed two (2) kinds of the tapes, having the width of 12 mm and 24 mm, on which the braille label can be produced, but they may be three (3) or more in the kinds thereof, or may be only one (1) kind thereof. In the case of limiting only to the one (1) kind, it can be expected that each process therein comes to be simplified.

(B-12) Mode of Guidance into Typing Head Portion 38

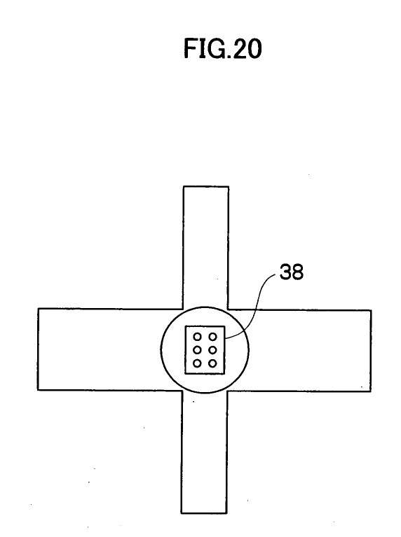

In the explanation of the embodiment mentioned above, as the method for enabling the tapes having plural number of tape widths to be guided into the typing head portion 38, there are disclosed the one of utilizing a difference of the inclination angles, as shown in FIG. 14, or the one, in which the guide wall is slidable in the width direction thereof; however, other methods or mechanism can be applied therein; for example, as shown in FIG. 20, a rotary member may be provided, which has a plural number of ruining paths corresponding to each of the tape widths, so as to be come across at the position of the typing head portion 38, and that rotary member can be rotated, manually, to cope with the tape width at that time.

(B-13) Mode Without Conducting Printing

In the embodiment mentioned above, the braille tamping tape to be provided into the typing process must be one, which has passed through the printing process, irrespective of the fact that the character line is printed or not on that; however, if it is the layout of including only the braille characters therein, and if selection is made onto the fixed length, which is defined by the system, through the fixed length function thereof, it is possible to execute the typing process onto the braille typing tape, not passing through the printing process yet (for example, the braille typing tape, which is already available on markets).

(B-14) Modes Relating to Sequences of Printing Process and Typing Process

Also, in the embodiment mentioned above, there is shown the running path for the braille typing tape guided into the printing process and the running path for the braille typing tape guided into the typing process, which are separated from each other; however, it is possible to guide the braille typing tape after being processed by the printing process onto the running path into the typing process, automatically, and in such the case, cutting of the tape may be conducted at a final state of the printing process, or at the final stage of the typing process.

In the embodiment mentioned above, it is disclosed that the typing process is conducted after the printing process; however, the sequence or the order of those processes should not be limited only to that. For example, in a case where an inkjet method or the like is applied to the printing structure, for example, the printing process can be also conducted onto the tape, after being formed with the convex portions thereon.

(B-15) Mode of Method for Forming Braille Characters

Further, with the embodiment mentioned above, there is disclosed that the convex portions are formed on the tape through the typing, however, other methods may be applied for forming the convex portions thereon. It may be one of bringing about the change of forming at a contact point of a heating pin, for example.

Furthermore, the braille characters (i.e., the cell patterns) may be printed on the tape, but without providing the typing structure, such as, the typing head, etc., thereby making the user forming the convex portions by the user, with using the dot pin, which is prepared as attachment parts of the system. The expression made in the claims should be construed to include producing thereof up to the condition immediately before that of completing the production thereof, i.e., printing the braille characters (i.e., the cell patterns) onto the tape.

(B-16) Mode of Inputting and Editing Method of Braille Contents

The inputting and editing method of the contents of braille characters should not be restricted to that shown in the embodiments mentioned above, and by taking the brailling rules into the consideration, there may be provided a function which is different from that of inputting the general characters.

For example, if “ [symbol] (beekeeping)” as a line of print characters is inputted erroneously in the place of “ [symbol] (a use)”, and at the stage when “ [symbol] - [symbol] - (yoh-ho: pronunciation for both “ [symbol] (beekeeping)” and “ [symbol] (a use)” in Japanese)” is inputted automatically, as the contents of braille characters, then the user deletes the “ [symbol] (beekeeping)” with respect to the print character line. And, if “ [symbol] (a use)” is inputted, then the contents of braille characters come to be “ [symbol] - [symbol] - [symbol] - [symbol] - (yoh-ho yoh-ho)”, but there may be provided a function of deleting the duplication, through confirmation by the user, onto repetition of the characters which is equal or larger than a predetermined number thereof. Further, for example, in the case where deletion is designated upon the “pre-statement” code indicating that the characters thereafter are the alphanumeric characters, while displaying a confirmation message of asking “Do you wish to delete only the pre-statement, or a whole of the pre-statement and the alphanumeric characters defined therewith?”, and then, the deletion may be executed, depending on the operation made by the user responding thereto.

(B-17) Mode of Tape Printing System

Also, in the embodiment mentioned above, there is disclosed the tape typing system (i.e., the tape printing apparatus), as a special purpose machine only for exclusive use thereof, however, the present invention may be applied to a tape printing system made up by combining an information processing apparatus, such as, a personal computer, and a label printer, as a peripheral device of the information processing apparatus. Further, in case of applying the present invention to the information processing apparatus, such as, the personal computer, there may be applied a selection method with an aid of the “drag and drop” function, or the like, which is very commonly applied to the personal computer and so on, as being the method for selecting out from choices, such as, that for the layout mentioned above, for example.

Further, although the braille label producing function is added onto the tape producing system, which has the normal label producing function in the embodiment mentioned above, a tape typing system can have only the braille label producing function mentioned above (including, the common writing pattern and the overwriting pattern), without the normal label producing function.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. A finger reading label producing system, comprising:
a finger reading contents take-in means for taking into finger reading contents;
a print character line take-in means for taking into a character line to be printed;
a printing means for printing the character line, into which said character line take-in means takes, on a finger reading label;
a convex portion producing means for producing convex portions corresponding to a reading content, into which said finger reading contents take-in means takes, on the finger reading label;
a label layout take-in means for taking into layout information relating to the finger reading contents of said finger reading label to be produced and/or the character line to be printed; and
a controller means for controlling said finger reading contents take-in means, said print character line take-in means, said printing means, and/or said convex portion producing means, in accordance with the layout information taken into.

2. The finger reading label producing system, as described in claim 1, wherein the finger reading contents, into which said finger reading contents take-in means takes, are contents of braille characters.

3. A finger reading label producing method, comprising:
a finger reading contents take-in step of taking into finger reading contents;
a print character line take-in step of taking into a character line to be printed;
a printing step of printing the character line, which are taken into in said character line take-in step, on a finger reading label;
a convex portion producing step of producing convex portions corresponding to the finger reading contents, which are taken into in said finger reading contents take-in step, on the finger reading label;
a label layout take-in step of taking into layout information relating to the finger reading contents of said finger reading label to be produced or the character line to be printed; and
a controlling step of controlling sequences of processes among plural numbers of said steps and transmission of information exchange among the plural numbers of said steps in accordance with the layout information taken into.

4. The finger reading label producing method, as described in claim 3, wherein the finger reading contents, which are taken into in said finger reading contents take-in step, are contents of braille characters.

5. A finger reading label producing program, describing each of the steps of said finger reading label producing method described in claim 3, with codes which can be executed by a computer.

6. A computer program product for use with a computer, comprising:
a computer readable medium with a computer program recorded thereon, the program including the steps of said finger reading label producing method described in claim 3, being described with codes which can be executed by the computer.
